(19) United States
(12) Patent Application Publication
(10) Pub. No.: US 2012/0117745 A1
(43) Pub. Date: May 17, 2012

(54) ON-BOARD OPTICAL SENSOR COVER AND ON-BOARD OPTICAL SENSOR APPARATUS

(75) Inventors: Toshihiro HATTORI, Okazaki-city (JP); Manabu ONO, Okazaki-city (JP)

(73) Assignee: DENSO CORPORATION, Kariya-city (JP)

(21) Appl. No.: 13/355,672

(22) Filed: Jan. 23, 2012

Related U.S. Application Data
(63) Continuation-in-part of application No. 12/923,482, filed on Sep. 23, 2010.

(30) Foreign Application Priority Data
Sep. 29, 2009 (JP) 2009-224490
Apr. 20, 2010 (JP) 2010-96894
Aug. 3, 2010 (JP) 2010-174449
Mar. 7, 2011 (JP) 2011-48924

(51) Int. Cl. B60S 1/52; B60S 1/04; B08B 3/02

(52) U.S. Cl. 15/250.01; 134/198; 134/105

(57) ABSTRACT

An on-board optical sensor cover includes a holder and a washer nozzle. The holder holds an optical sensor. The optical sensor has a lens and is mounted above a window of a vehicle outside the vehicle. The washer nozzle performs a washing operation to wash a lens surface of the lens of the optical sensor held in the holder or a glass surface of a cover glass located facing the lens if the cover glass exists by spraying a washer fluid, supplied from a washer fluid tank, onto the lens surface or the glass surface. The optical sensor cover is located above the window outside the vehicle so that the washer fluid spayed from the washer nozzle flows to a window surface of the window after washing the lens surface or the glass surface.

### CROSS REFERENCE TO RELATED APPLICATION

This application is a continuation-in-part of application Ser. No. 12/923,482 filed on Sep. 23, 2010 and related to Japanese Patent Applications No. 2009-224490 filed on Sep. 29, 2009, No. 2010-96894 filed on Apr. 20, 2010, No. 2010-174449 filed on Aug. 3, 2010, and No. 2011-48924 filed on Mar. 7, 2011, the contents of which are incorporated herein by reference.

### FIELD OF THE INVENTION

The present invention relates to an on-board optical sensor cover used in combination with an optical sensor such as a camera or a laser mounted on a vehicle, and also relates to an on-board optical sensor apparatus including the on-board optical sensor cover and the optical sensor.

### BACKGROUND OF THE INVENTION

In recent years, there has been a trend that a vehicle is equipped with an optical sensor such as a camera or a laser. It has been proposed that a compressed air generator for spraying compressed air is used to remove foreign matters such as water and dirt sticking to a lens surface of a lens of the optical sensor and that the foreign matters sticking to the lens surface is removed by spraying the compressed air from the compressed air generator onto the lens surface of the lens (refer to, for example, JP 2001-171491 A).

However, according to a technique disclosed in JP 2001-171491 A, the compressed air generator for spraying the compressed air is required. As a result, the cost and the size are increased.

### SUMMARY OF THE INVENTION

In view of the above, it is an object of the present invention is to provide an on-board optical sensor cover and an on-board optical sensor apparatus for suitably removing a foreign matter sticking to a lens surface of a lens or a glass surface of a cover glass facing the lens while reducing the cost and the size by making a compressed air generator for spraying compressed air unnecessary.

According to an aspect of the present invention, an on-board optical sensor cover includes a holder and a washer nozzle. The holder holds an optical sensor. The optical sensor has a lens and is mounted above a window of a vehicle outside the vehicle. The washer nozzle performs a washing operation to wash a lens surface of the lens of the optical sensor held in the holder or a glass surface of a cover glass located facing the lens if the cover glass exists by spraying a washer fluid, supplied from a washer fluid tank, onto the lens surface or the glass surface. The optical sensor cover is located above the window outside the vehicle so that the washer fluid spayed from the washer nozzle flows to a window surface of the window after washing the lens surface or the glass surface.

According to another aspect of the present invention, an on-board optical sensor apparatus includes the on-board optical sensor cover and a control device. The control device causes the washer nozzle to perform the washing operation and causes a wiper of the vehicle to perform a wiping operation to wash a window surface of the window by wiping the window surface. The control device interlocks the washing operation of the washer nozzle and the wiping operation of the wiper.

### BRIEF DESCRIPTION OF THE DRAWINGS

The above and other objectives, features and advantages of the present invention will become more apparent from the following detailed description made with check to the accompanying drawings. In the drawings:

FIG. 1A is a diagram illustrating a front view of an optical sensor unit according to a first embodiment of the present invention, and FIG. 1B is a diagram illustrating a cross-sectional side view of the optical sensor unit of FIG. 1A;

FIG. 2 is a diagram illustrating a manner in which a camera cover and a camera of the optical sensor unit according to the first embodiment are separated from each other;

FIG. 3 is a diagram illustrating a perspective view of a vehicle equipped with the optical sensor unit according to the first embodiment;

FIG. 4 is a functional diagram of the optical sensor unit according to the first embodiment;

FIG. 5 is a flow chart of the optical sensor unit according to the first embodiment;

FIG. 6 is a functional diagram of an optical sensor unit according to a second embodiment of the present invention;

FIG. 7 is a flow chart of the optical sensor unit according to the second embodiment;

FIG. 8A is a diagram illustrating a front view of an optical sensor unit according to a modification of the first and second embodiments, and

FIG. 8B is a diagram illustrating a cross-sectional side view of the optical sensor unit of FIG. 8A;

FIG. 9A is a diagram illustrating a front view of an optical sensor unit according to another modification, and FIG. 9B is a diagram illustrating a cross-sectional side view of the optical sensor unit of FIG. 9A;

FIG. 10A is a diagram illustrating a front view of an optical sensor unit according to another modification, and FIG. 10B is a diagram illustrating a cross-sectional side view of the optical sensor unit of FIG. 10A;

FIG. 11A is a diagram illustrating a front view of an optical sensor unit according to another modification, and FIG. 11B is a diagram illustrating a cross-sectional side view of the optical sensor unit of FIG. 11A;

FIG. 12A is a diagram illustrating a front view of an optical sensor unit according to another modification, and FIG. 12B is a diagram illustrating a cross-sectional side view of the optical sensor unit of FIG. 12A;

FIG. 13A is a diagram illustrating a front view of an optical sensor unit according to another modification, and FIG. 13B is a diagram illustrating a cross-sectional side view of the optical sensor unit of FIG. 13A;

FIG. 14A is a diagram illustrating a front view of an optical sensor unit according to another modification, and FIG. 14B is a diagram illustrating a cross-sectional side view of the optical sensor unit of FIG. 14A;

FIG. 15A is a diagram illustrating a front view of an optical sensor unit according to another modification, and FIG. 15B is a diagram illustrating a cross-sectional side view of the optical sensor unit of FIG. 15A;

FIG. 16A is a diagram illustrating a front view of an optical sensor unit according to another modification, and FIG. 16B is a diagram illustrating a cross-sectional side view of the optical sensor unit of FIG. 16A;

FIG. 17A is a diagram illustrating a front view of an optical sensor unit according to another modification, and FIG. 17B is a diagram illustrating a cross-sectional side view of the optical sensor unit of FIG. 17A;

FIG. 18A is a diagram illustrating a front view of an optical sensor unit according to another modification, and FIG. 18B is a diagram illustrating a cross-sectional side view of the optical sensor unit of FIG. 18A;

FIG. 19A is a diagram illustrating a front view of an optical sensor unit according to another modification, and FIG. 19B is a diagram illustrating a cross-sectional side view of the optical sensor unit of FIG. 19A;

FIG. 20 is a diagram illustrating a front view of an optical sensor unit according to another modification;

FIG. 21 is a diagram illustrating a front view of an optical sensor unit according to another modification;

FIG. 22 is a functional diagram of the optical sensor unit of FIG. 21;

FIGS. 23A and 23B are diagrams illustrating a perspective view of a vehicle equipped with an optical sensor unit according to another modification;

FIG. 24A is a diagram illustrating a front view of an optical sensor unit according to a third embodiment of the present invention, and FIG. 24B is a diagram illustrating a cross-sectional side view of the optical sensor unit of FIG. 24A;

FIG. 25 is a diagram illustrating a manner in which a camera cover and a camera of the optical sensor unit according to the third embodiment are separated from each other;

FIG. 26 is a functional diagram of the optical sensor unit according to the third embodiment;

FIG. 27 is a flow chart of the optical sensor unit according to the third embodiment;

FIG. 28 is a functional diagram of an optical sensor unit according to a fourth embodiment of the present invention;

FIG. 29 is a flow chart of the optical sensor unit of the fourth embodiment;

FIG. 30A is a diagram illustrating a front view of an optical sensor unit according to a modification of the third and fourth embodiments, and

FIG. 30B is a diagram illustrating a cross-sectional side view of the optical sensor unit of FIG. 30A;

FIG. 31A is a diagram illustrating a front view of an optical sensor unit according to another modification, and FIG. 31B is a diagram illustrating a cross-sectional side view of the optical sensor unit of FIG. 31A;

FIG. 32A is a diagram illustrating a front view of an optical sensor unit according to another modification, and FIG. 32B is a diagram illustrating a cross-sectional side view of the optical sensor unit of FIG. 32A;

FIG. 33A is a diagram illustrating a front view of an optical sensor unit according to another modification, and FIG. 33B is a diagram illustrating a cross-sectional side view of the optical sensor unit of FIG. 33A;

FIG. 34A is a diagram illustrating a front view of an optical sensor unit according to another modification, and FIG. 34B is a diagram illustrating a cross-sectional side view of the optical sensor unit of FIG. 34A;

FIG. 35A is a diagram illustrating a front view of an optical sensor unit according to another modification, and FIG. 35B is a diagram illustrating a cross-sectional side view of the optical sensor unit of FIG. 35A;

FIG. 36A is a diagram illustrating a front view of an optical sensor unit according to another modification, and FIG. 36B is a diagram illustrating a cross-sectional side view of the optical sensor unit of FIG. 36A;

FIG. 37A is a diagram illustrating a front view of an optical sensor unit according to another modification, and FIG. 37B is a diagram illustrating a cross-sectional side view of the optical sensor unit of FIG. 37A;

FIG. 38A is a diagram illustrating a front view of an optical sensor unit according to another modification, and FIG. 38B is a diagram illustrating a cross-sectional side view of the optical sensor unit of FIG. 38A;

FIG. 39A is a diagram illustrating a front view of an optical sensor unit according to another modification, and FIG. 39B is a diagram illustrating a cross-sectional side view of the optical sensor unit of FIG. 39A;

FIG. 40A is a diagram illustrating a front view of an optical sensor unit according to another modification, and FIG. 40B is a diagram illustrating a cross-sectional side view of the optical sensor unit of FIG. 40A;

FIG. 41A is a diagram illustrating a front view of an optical sensor unit according to another modification, and FIG. 41B is a diagram illustrating a cross-sectional side view of the optical sensor unit of FIG. 41A;

FIG. 42A is a diagram illustrating a front view of an optical sensor unit according to another modification, and FIG. 42B is a diagram illustrating a cross-sectional side view of the optical sensor unit of FIG. 42A;

FIG. 43A is a diagram illustrating a front view of an optical sensor unit according to another modification, and FIG. 43B is a diagram illustrating a cross-sectional side view of the optical sensor unit of FIG. 43A;

FIG. 44A is a diagram illustrating a front view of an optical sensor unit according to another modification, and FIG. 44B is a diagram illustrating a cross-sectional side view of the optical sensor unit of FIG. 44A;

FIG. 45A is a diagram illustrating a front view of an optical sensor unit according to another modification, and FIG. 45B is a diagram illustrating a cross-sectional side view of the optical sensor unit of FIG. 45A;

FIG. 46A is a diagram illustrating a front view of an optical sensor unit according to another modification, and FIG. 46B is a diagram illustrating a cross-sectional side view of the optical sensor unit of FIG. 46A;

FIG. 47A is a diagram illustrating a front view of an optical sensor unit according to another modification, and FIG. 47B is a diagram illustrating a cross-sectional side view of the optical sensor unit of FIG. 47A;

FIG. 48A is a diagram illustrating a front view of an optical sensor unit according to another modification, and FIG. 48B is a diagram illustrating a cross-sectional side view of the optical sensor unit of FIG. 48A;

FIG. 49A is a diagram illustrating a front view of an optical sensor unit according to another modification, and FIG. 49B is a diagram illustrating a cross-sectional side view of the optical sensor unit of FIG. 49A;

FIG. 50 is a diagram illustrating a manner in which washer fluid is removed in the optical sensor unit of FIGS. 49A and 49B;

FIG. 51A is a diagram illustrating a front view of an optical sensor unit according to another modification, and FIG. 51B is a diagram illustrating a cross-sectional side view of the optical sensor unit of FIG. 51A;

FIG. 52A is a diagram illustrating a front view of an optical sensor unit according to another modification, and FIG. 52B is a diagram illustrating a cross-sectional side view of the optical sensor unit of FIG. 52A;

FIG. 53 is a flow chart of an optical sensor unit according to another modification of the fourth embodiment;

FIG. 54 is a diagram illustrating an image captured by the camera;

FIG. 55A is a diagram illustrating a front view of an optical sensor unit according to another modification, and FIG. 55B is a diagram illustrating a cross-sectional side view of the optical sensor unit of FIG. 55A;

FIG. 56 is a diagram illustrating an exploded view of the optical sensor unit of FIGS. 55A and 55B;

FIG. 57 is a diagram illustrating a perspective view of a vehicle equipped with the optical sensor unit of FIGS. 55A and 55B;

FIG. 58 is a functional diagram of the optical sensor unit of FIGS. 55A and 55B;

FIG. 59 is a flow chart of the optical sensor unit of FIGS. 55A and 55B; and

FIG. 60A is a diagram illustrating a front view of an optical sensor unit according to another modification, and FIG. 60B is a diagram illustrating a cross-sectional side view of the optical sensor unit of FIG. 60A.

### DETAILED DESCRIPTION OF THE PREFERRED EMBODIMENTS

### First Embodiment

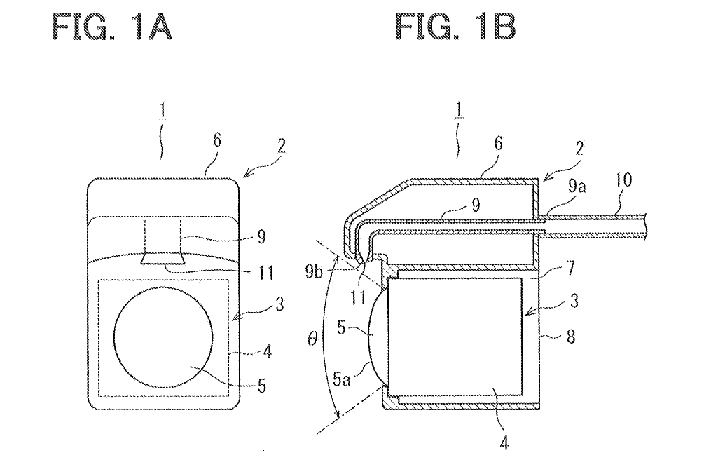

A first embodiment related to a camera embodying an optical sensor of the present invention is described below with reference to FIGS. 1A-5.

As shown in FIGS. 1A and 1B, an optical sensor unit 1 (an on-board optical sensor apparatus of the present invention) includes a camera cover 2 (an on-board optical sensor cover of the present invention) and a camera 3. The camera 3 is attached to the camera cover 2 in a detachable manner. In the camera 3, a lens 5 is located on a front side (a left side in FIG. 1B) of a casing 4, and a power supply line (not shown) and an image signal output line (not shown) are drawn from a rear side (a right side in FIG. 1B) of the casing 4. The power supply line is used to supply power to the camera 3. The image signal output line is used to output an image signal. The lens 5 is a fisheye lens and has a curved lens surface 5a that can take a wide-angle image.

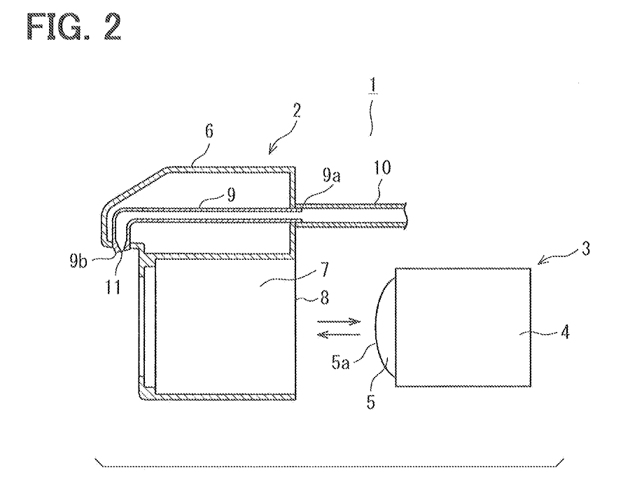

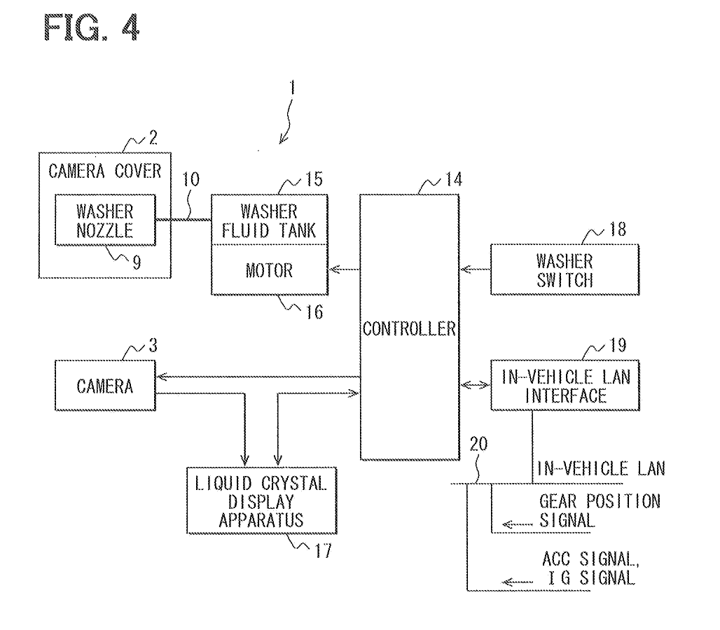

In the camera cover 2, a holder 7 for holding the camera 3 is located in a casing 6, and an opening 8 is located on a rear side of the casing 6. As shown in FIG. 2, the camera 3 is attached to the camera cover 2 through the opening 8 and detached from the camera cover 2 through the opening 8. In the camera cover 2, a washer nozzle 9 is located above the holder 7. The washer nozzle 9 has a “L” shape. A base end 9a of the washer nozzle 9 is connected to a tube 10 on the rear side of the casing 6. A tip end 9b of the washer nozzle 9 has an opening directed downward and serves as a spray opening 11. In a condition where the camera 3 is normally held in the holder 7 (in a normal use condition shown in FIGS. 1A and 1B), the lens surface 5a of the lens 5 of the camera 3 is located directly below the tip end 9b of the washer nozzle 9. It is noted that the spray opening 11 of the washer nozzle 9 is located in an area outside an angle of view (indicated by FIG. 4 is a functional block diagram illustrating an electrical configuration of peripheral circuitry including the optical sensor unit 1. The on-board optical sensor apparatus of the present invention includes the optical sensor unit 1 and a controller 14. The controller 14 (a control device, a gear position detection device, a vehicle activation start detection device, a vehicle activation end detection device, an image dirt detection device, or an image fog detection device of the present invention) mainly includes a microcomputer. The controller 14 executes a prestored control program, thereby controlling a capture operation of the camera 3 and controlling an operation of a motor 16 installed in a washer fluid tank 15 so as to control a washing operation of the washer nozzle 9.

In this case, when the motor 16 is driven, a washer fluid stored in the washer fluid tank 15 is supplied to the washer nozzle 9 through the tube 10. The washer fluid supplied to the washer nozzle 9 is hydraulically splayed from the spray opening 11 onto the lens surface 5a of the lens 5 of the camera 3. The washer fluid can be sprayed in various manners. For example, the washer fluid can be sprayed onto the lens surface 5a in the form of a mist. For another example, a moderate amount of the washer fluid can be supplied to the lens surface 5a in the form of a grain that is not finer than the mist. For further another example, a predetermined amount of the washer fluid can be supplied to the lens surface 5a in the form of a block at a time. It is noted that the washer fluid tank 15 is installed in a typical engine room of the vehicle body 12.

A liquid crystal display apparatus 17 (a reporting device of the present invention) is located in a vehicle compartment. When receiving the image signal outputted from the camera 3, the liquid crystal display apparatus 17 displays an image corresponding to the image signal by decoding the image signal. The controller 14 detects whether the image contains dirt or fog by analyzing the image displayed on the liquid crystal display apparatus 17 (for example, by determining whether pixel brightness is large or small).

A washer switch 18 is operable by a user. When a user operates the washer switch 18, the washer switch 18 outputs an operation detection signal to the controller 14. When receiving the operation detection signal outputted from the washer switch 18, the controller 14 outputs a drive command signal to the motor 16, thereby driving the motor 16. For example, the drive command signal outputted from the controller 14 to the motor 16 is a level signal, and the washing operation of the washer nozzle 9 is performed only during a period of time where the level signal is ON (high level). The washer switch 18 can be a mechanical switch or a touch switch displaced on the liquid crystal display apparatus 17.

An in-vehicle LAN interface 19 receives a gear position signal indicative of a position of a gear of the vehicle, an ACC signal indicative of an ON/OFF state of an ACC (accessory) switch, and an IG signal indicative of an ON/OFF state of an IG (ignition) switch from various types of ECUs through an in-vehicle LAN 22. Then, the in-vehicle LAN interface 19 outputs the received various types of signals to the controller 14. When receiving the various types of signals outputted from the in-vehicle LAN interface 19, the controller 14 analyzes the received various types of signals, thereby detecting the position of the gear, the ON/OFF state of the ACC switch, and the ON/OFF state of the IG switch.

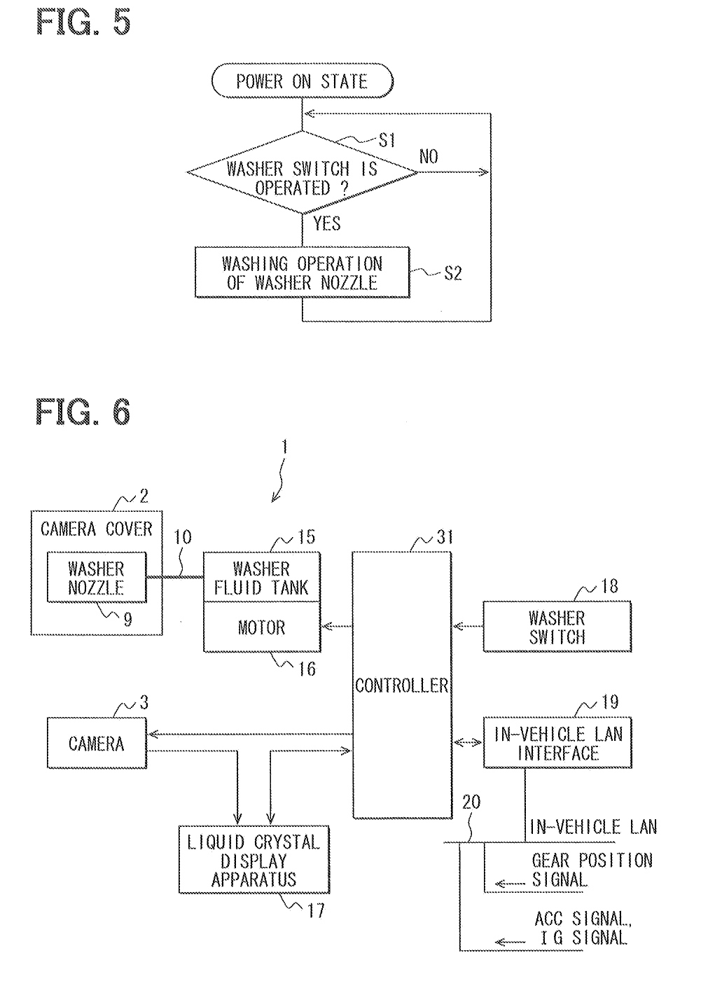

Next, an action of the above configuration is described below with reference to FIG. 5.

In a power-ON state (in a driven state of the optical sensor unit 1), the controller 14 determines whether the washer switch 18 is operated (step S1). When the controller 14 receives the operation detection signal outputted from the washer switch 18 and determines that the washer switch 18 is operated (“YES” at step S1), the controller 14 outputs the drive commend signal to the motor 16 to drive the motor 16, thereby performing the washing operation of the washer nozzle 9 (step S2). That is, the washer fluid stored in the washer fluid tank 15 is supplied to the washer nozzle 9 and splayed from the spray opening 11 onto the lens surface 5a of the lens 5 of the camera 3. In this case, the controller 14 can continue the washing operation of the washer nozzle 9 only for a predetermined period of time (for example, a few seconds). Alternatively, the controller 14 can continue the washing operation of the washer nozzle 9 only while a user is operating (for example, pressing) the washer switch 18. Further, if a function of measuring the amount of the washer fluid is included, the washing operation of the washer nozzle 9 can be continued only until the amount of the splayed washer fluid reaches a predetermined amount. It is noted that the controller 14 repeats the above steps S1, S2.

As described above, according to the first embodiment, the camera cover 2 attachable to and detachable from the camera 3 is provide with the washer nozzle 9 for spraying the washer fluid supplied from the washer fluid tank 15 onto the lens surface 5a of the lens 5 of the camera 3 so as to wash the lens surface 5a. In such an approach, a conventional compressed air generating unit for spraying compressed air is made unnecessary so that cost and size can be reduced. A foreign matter sticking to the lens surface 5a is suitably removed so that the camera 3 can suitably work. Further, since the camera cover 2 is attachable to and detachable from the camera 3 can be independently replaced easily.

### Second Embodiment

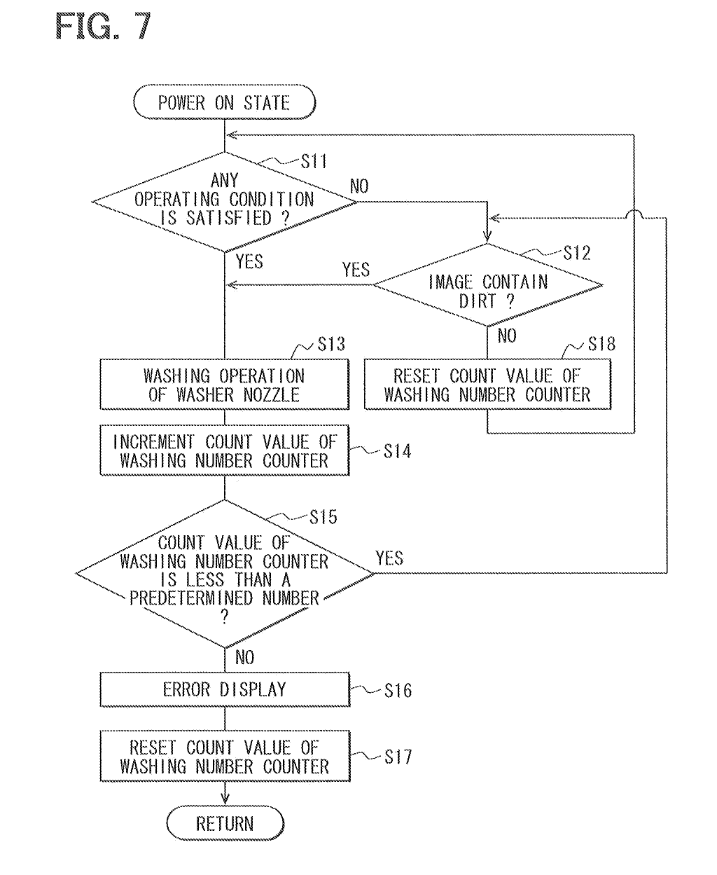

A second embodiment of the present invention is described below with reference to FIGS. 6 and 7. The second embodiment differs from the first embodiment in the following points. In the first embodiment, the washing operation of the washer nozzle 9 is triggered when the washer switch 18 is operated by a user. That is, the washing operation of the washer nozzle 9 is manually performed. In the second embodiment, operating conditions include detection of the fact that the gear is shifted into a reverse position (detection of the fact that a gear of a vehicle is in a predetermined position in the present invention), detection of the fact that the IG switch is switched from an OFF state to an ON state (detection of the fact that activation of a vehicle is started in the present invention), and detection of the fact that the IG switch is switched from the ON state to the OFF state (detection of the fact that activation of a vehicle is ended in the present invention). The washing operation of the washer nozzle 9 is triggered when any of the operating conditions is satisfied or when the image contains dirt. That is, the washing operation of the washer nozzle 9 is automatically performed. A controller 31 according to the second embodiment has a counting function.

In FIG. 7, in the power-ON state (in the driven state of the optical sensor unit 1), the controller 31 determines whether any of the operating conditions is satisfied (step S11) and determines whether the image contains dirt (step S12). Then, if the controller 31 determines that any of the operating conditions is satisfied, i.e., determines that the gear is shifted into the reverse position, the IG switch is switched from the OFF state to the ON state, or the IG switch is switched from the ON state to the OFF state (“YES” at step S11), or if the controller 31 determines that the image contains dirt (“YES” at step S12), the controller 31 drives the motor 16, thereby performing the washing operation of the washer nozzle 9 for a predetermined period of time (step S13).

Then, the controller 31 increments (addition of “1”) a washing number counter (step S14) and determines whether a value of the incremented washing number counter is less than a predetermined number (step S15). If the controller 31 determines that the value of the incremented washing number counter is less than the predetermined number (“YES” at step S15), the controller 31 returns to step S12 and repeats the steps subsequent to step S12. In contrast, if the controller 31 determines that the value of the incremented washing number counter is equal to or greater than the predetermined number (“NO” at step S15), the controller 31 causes the liquid crystal display apparatus 17 to display an error display indicating that the washing operation of the washer nozzle 9 was performed the predetermined number of times (step S16). Then, the controller 31 resets the value of the washing number counter (step S17) and finishes the series of procedures.

If the controller 31 determines that the image contains no dirt (dirt is removed as a result of the washing operation of the washer nozzle 9) (“NO” at step S12), the controller 31 resets the value of the washing number counter (step S18), then returns to step S11, and repeats the steps subsequent to step S11.

As described above, according to the second embodiment, the lens surface 5a of the lens 5 of the camera 3 can be automatically washed whenever it is detected that the gear of the vehicle is shifted into the reverse position, the IG switch is switched from the OFF state to the ON state, the IG switch is switched from the ON state to the OFF state, or the image contains dirt. Further, the error display is displayed when the washing number counter becomes equal to or greater than the predetermined number. Alternatively, if a function of measuring the washing time is included, the error display can be displayed when the washing time reaches a predetermined time.

The embodiments described above can be modified or extended as follows.

The optical sensor is not limited to the camera 3 and can be a sensor, such as a laser, that has a lens and optically measures a physical quantity.

In the embodiments, in the case where the value of the washing number counter becomes equal to or greater than the predetermined number, the error display is displayed on the liquid crystal display apparatus 17. Alternatively, in such a case, an error surround can be outputted from a speaker, or vibration or static electricity can be generated from a seat or a handle by a static electricity generator or a vibration generator mounted to the seat or the handle. Alternatively, these can be used in combination with each other. That is, reporting can be performed through any of the sense of sight, the sense of hearing, and the sense of touch.

The configuration, shown in FIG. 5, in which the washing operation of the washer nozzle 9 is manually performed, can be used in combination with the configuration, shown in FIG. 7, in which the washing operation of the washer nozzle 9 is automatically performed.

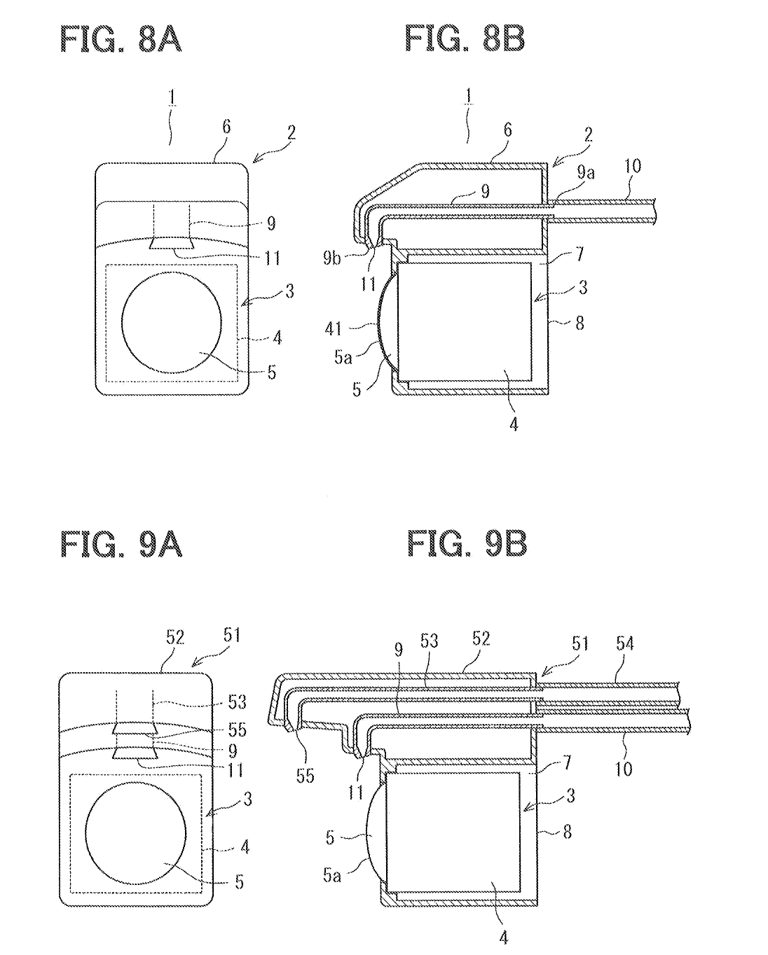

As shown in FIGS. 8A and 8B, a water-repellent treatment can be applied to the lens surface 5a of the lens 5 of the camera 3 so that the lens surface 5a can be coated with a water-repellent layer 41. Alternatively, a hydrophilic treatment, a photocatalytic treatment, or an antifouling treatment can be applied to the lens surface 5a so that the lens surface 5a can be coated with a hydrophilic layer, a photocatalytic layer, or an antifouling layer. In such an approach, it is possible to prevent foreign matters such as water and dirt from sticking to the lens surface 5a. Further, even if foreign matters such as water and dirt stick to the lens surface 5a, the washing operation of the washer nozzle 9 is performed so that the lens surface 5a can be suitably washed.

As shown in FIGS. 9A and 9B, a casing 52 of a camera cover 51 can be provided with a window washer nozzle 53 that is arranged parallel to the washer nozzle 9. The washer fluid stored in the washer fluid tank 15 can be supplied to the window washer nozzle 53 through a tube 54, and the washer fluid supplied to the window washer nozzle 53 can be splayed from a spray opening 55 onto a window. In such an approach, not only the lens surface 5a of the lens 5 of the camera 3 but also the window can be washed so that multiple functions can be achieved. Alternatively, a washer fluid tank for storing the washer fluid supplied to the window washer nozzle 53 can be provided separately from the washer fluid tank 15 for storing the washer fluid supplied to the washer nozzle 9. Alternatively, a spay direction of the spray opening 11 of the washer nozzle 9 can be variable so as to selectively perform an operation for spraying the washer fluid onto the lens surface 5a of the lens 5 of the camera 3 and an operation for spaying the washer fluid onto the window.

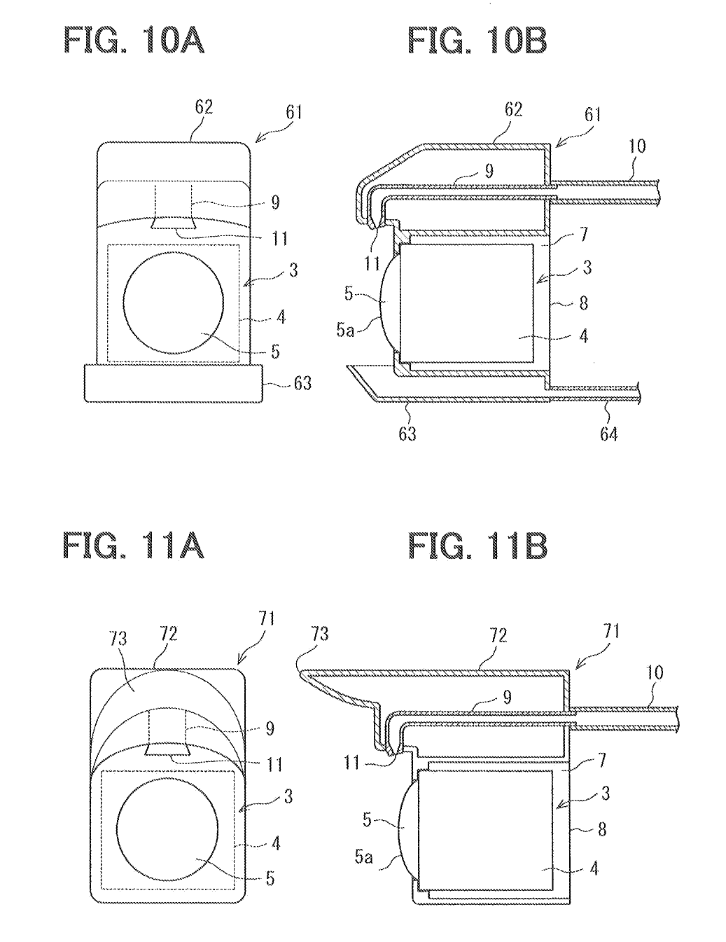

As shown in FIGS. 10A and 10B, a casing 62 of a camera cover 61 can be provided a pan 63 and a tube 64. When the washer fluid is sprayed from the splay opening 11 of the washer nozzle 9 onto the lens surface 5a of the lens 5 of the camera 3, the pan 63 can catch the washer fluid dripping from the lens surface 5a, and the washer fluid caught by the pan 63 can be drained through the tube 64. In such an approach, it is possible to prevent the window from becoming soiled by the washer fluid dripping from the lens surface 5a. Alternatively, the pan can have a hole, and the washer fluid dripping from the lens surface 5a can be supplied to the window through the hole so that the window can be washed.

As shown in FIGS. 11A and 11B, a casing 72 of a camera cover 71 can be provided with a canopy 73. The canopy 73 has a projection for covering the lens surface 5a from above. In such an approach, it is possible to prevent foreign matters such as water and dirt (in particular, raindrop) coming from above from sticking to the lens surface 5a.

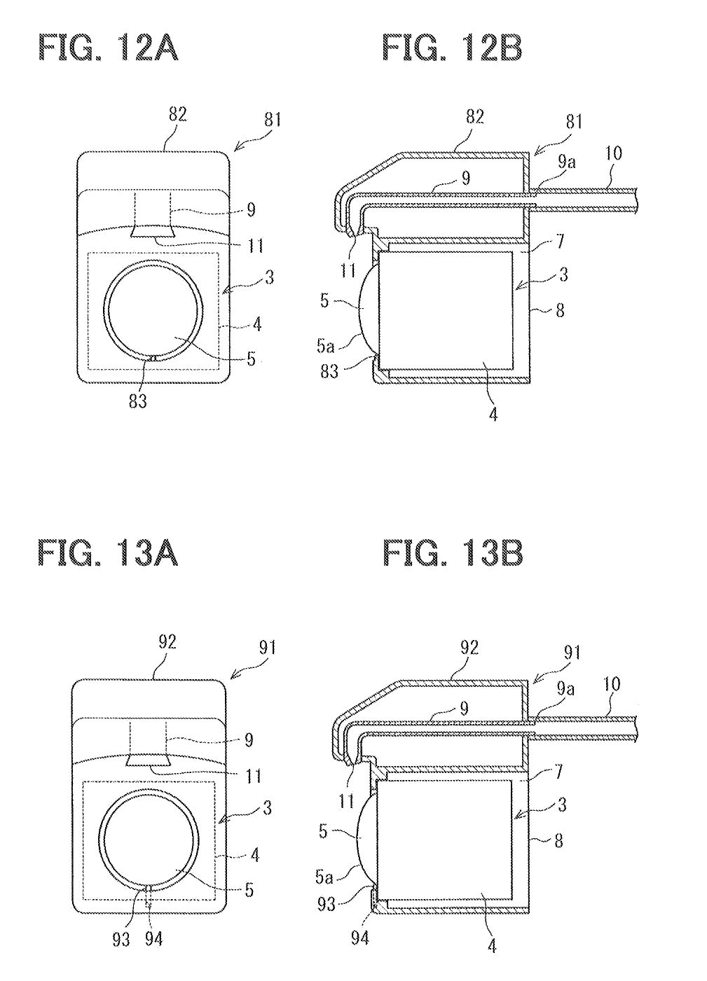

As shown in FIGS. 12A and 12B, a casing 82 of a camera cover 81 can be provided with a projection 83 that is located at a position (directly below the lens 5) near a bottom edge of the lens surface 5a of the lens 5 of the camera 3. In such an approach, even if water accumulates in the bottom edge of the lens surface 5a, the water accumulating in the bottom edge of the lens surface 5a comes in contact with the projection 83, is guided below the lens surface 5a, and thus removed.

The position where the water accumulates in the bottom edge of the lens surface 5a varies depending on the curvature and diameter of the lens 5. For this reason, as shown in FIGS. 13A and 13B, a casing 92 of a camera cover 91 can be provided with a projection 93. The projection 93 can be located at the position near the bottom edge of the lens surface 5a of the lens 5 of the camera 3 and move up and down along a slot 94. For example, when the diameter of the lens 5 is large, the projection 93 can be caused to move down, and when the diameter of the lens 5 is small, the projection 93 can be caused to move up. In this way, by causing the projection 93 to move up and down, the projection 93 can suitably come in contact with the water regardless of the curvature and diameter of the lens 5. For example, the projection 93 can be provided with a male screw portion, and the slot 94 can be provided with a female screw portion. The male screw portion and the female screw portion are engaged with each other so that the projection 93 can move up and down along the slot 94.

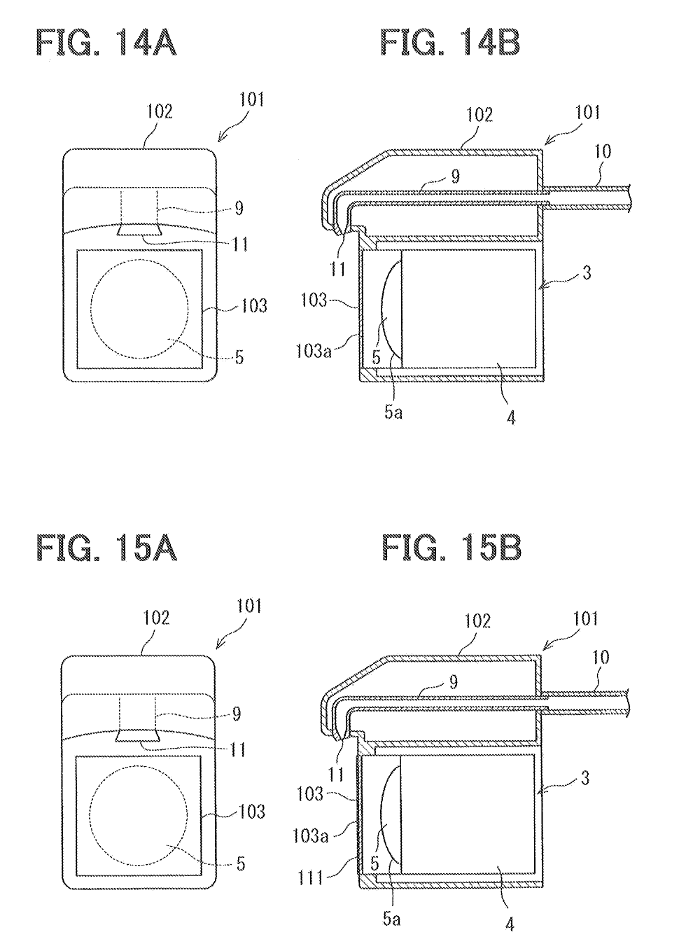

As shown in FIGS. 14A and 14B, a casing 102 of a camera cover 101 can be provided with a transparent cover glass 103. The cover glass 103 can be located on the front side of the casing 102 so as to face the lens 5 of the camera 3. The washer fluid supplied from the washer fluid tank 15 to the washer nozzle 9 through the tube 10 can be splayed from the spray opening 11 onto a glass surface 103a of the cover glass 103. In this case, since the entire camera 3 is held the casing 102, a size of the casing 102 in a front-rear direction (from a front side to a rear side) of the casing 102 is greater than a size of the casing 6 of the first and second embodiments. In such an approach, the cover glass 103 protects the lens 5 of the camera 3, and the washer fluid is suitably sprayed onto the glass surface 103a so that foreign matters sticking to the glass surface 103a can be suitably removed. Thus, the camera 3 can suitably work so as to capture a suitable image of the subject.

As shown in FIGS. 15A and 15B, a water-repellent treatment can be applied to the glass surface 103a of the cover glass 103 so that the glass surface 103a can be coated with a water-repellent layer 111. Alternatively, a hydrophilic treatment, a photocatalytic treatment, or an antifouling treatment can be applied to the glass surface 103a so that the glass surface 103a can be coated with a hydrophilic layer, a photocatalytic layer, or an antifouling layer. In such an approach, it is possible to prevent foreign matters such as water and dirt from sticking to the glass surface 103a. Further, even if foreign matters such as water and dirt stick to the glass surface 103a, the washing operation of the washer nozzle 9 is performed so that the glass surface 103a can be suitably washed.

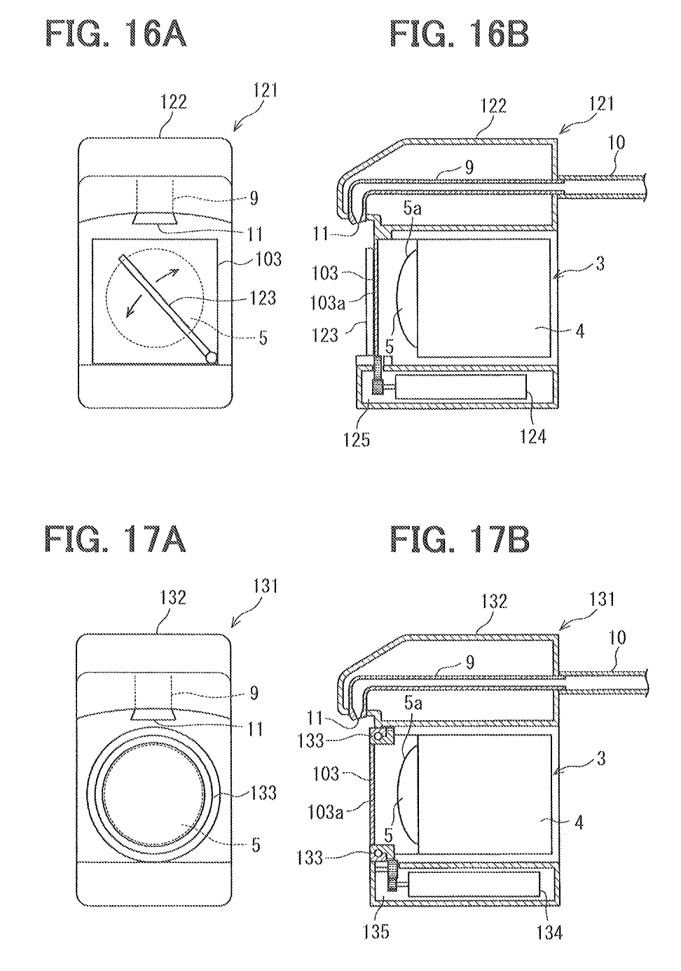

As shown in FIGS. 16A and 16B, a casing 122 of a camera cover 121 can be provided with a wiping mechanism 125 (a wiping device in the present invention). The wiping mechanism 125 includes a wiper 123 for wiping the glass surface 103a of the cover glass 103 and a motor 124 for driving the wiper 123. The wiping mechanism 125 can wipe the glass surface 103a of the cover glass 103, while or after the washer fluid is sprayed onto the glass surface 103a of the cover glass 103 from the spray opening 11 of the washer nozzle 9. In such an approach, it is possible to prevent the washer fluid from remaining sticking to the glass surface 103a of the cover glass 103. Alternatively, if the cover glass 103 is not included, a wiping mechanism for wiping the lens surface 5a of the lens 5 of the camera 3 can be included.

As shown in FIGS. 17A and 17B, a casing 132 of a camera cover 131 can be provided with a rotating mechanism 135 (a rotating device in the present invention). The rotating mechanism 135 includes a sealed bearing 133 and a motor 134 for causing the cover glass 103 to rotate. The rotating mechanism 135 can cause the cover glass 103 to rotate, while or after the washer fluid is sprayed from the spray opening 11 of the washer nozzle 9 onto the glass surface 103a of the cover glass 103. In such an approach, while the cover glass 103 rotates, the washer fluid sticking to the glass surface 103a of the cover glass 103 can be blown off. Therefore, it is possible to prevent the washer fluid from remaining sticking to the glass surface 103a of the cover glass 103. In this case, for example, if a person touches the cover glass 103, the rotation is interfered so that its full potential of removing the washer fluid cannot be used. To prevent this, the rotating mechanism 135 can cause the cover glass 103 to rotate on the condition that a vehicle speed is greater than or equal to a predetermined speed (for example, 1 That is, typically, a person outside a vehicle can approach a vehicle, when the vehicle is parked or stopped. Therefore, when the vehicle is parked or stopped, there is a possibility that the person will accidentally touch the cover glass 103. However, the person does not approach the vehicle, when the vehicle is running. Therefore, when the vehicle is running, there is no possibility that the person will accidentally touch the cover glass 103. For the foregoing reasons, the rotating mechanism 135 can be configured to cause the cover glass 103 to rotate on the condition that the vehicle speed is greater than or equal to the predetermined speed. In such an approach, it is possible to prevent a reduction in the washer fluid removing potential due to a touch of the person outside the vehicle.

If the cover glass 103 is located where, such as at a door mirror, an occupant of the vehicle can reach it, it is preferable to take measures to prevent the occupant from touching it. For this reason, the rotating mechanism 135 can be configured to cause the cover glass 103 to rotate on the condition that the window is closed. In such an approach, it is possible to prevent a problem caused by a touch of the occupant to the cover glass 103 that is rotating. In this case, it is not always necessary that the window should be closed. It does no matter if the window is slightly opened, as long as the window is closed to a position that can prevent a user from touching the cover glass 103 by leaning out of the window. In this case, air can be introduced through the window. The position to which the window should be closed can be determined based on a relationship between where the cover glass 103 is located in the vehicle and how much a user can lean out of the window.

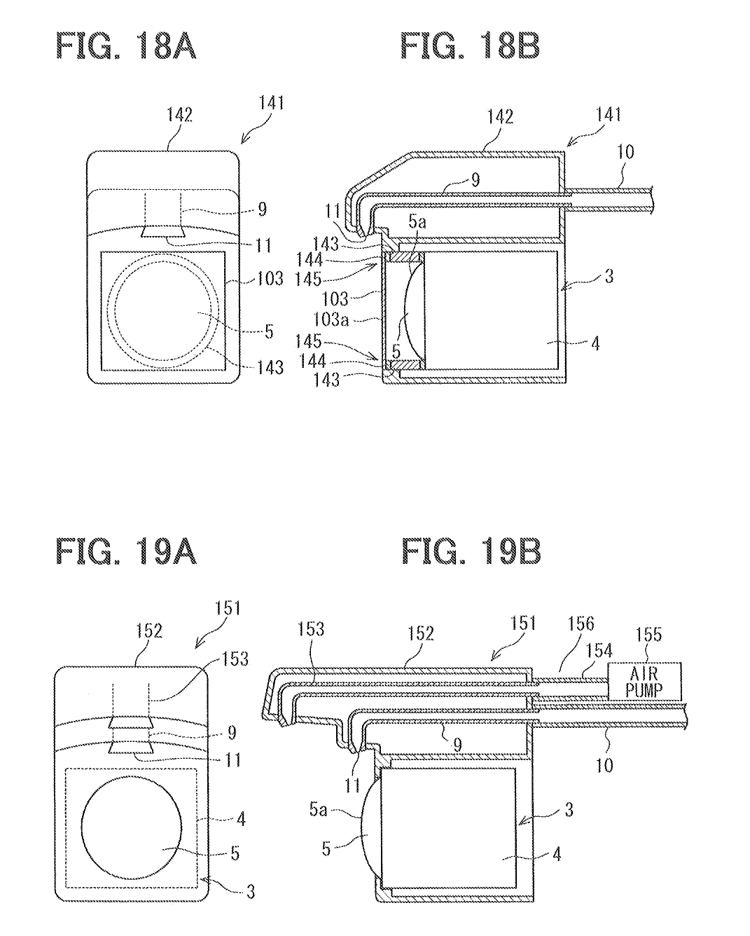

As shown in FIGS. 18A and 18B, a casing 142 of a camera cover 141 can be provided with a vibrating mechanism 145 (an ultrasonic vibration device or a subsonic vibration device in the present invention). The vibrating mechanism 145 includes a piezoelectric device 143 and an electrode 144 for generating ultrasonic wave or subsonic wave that causes the cover glass 103 to vibrate. The vibrating mechanism 145 can cause the cover glass 103 to vibrate, while or after the washer fluid is sprayed from the spray opening 11 of the washer nozzle 9 onto the glass surface 103a of the cover glass 103. In such an approach, it is possible to prevent the washer fluid from remaining sticking to the glass surface 103a of the cover glass 103.

As shown in FIGS. 19A and 19B, a casing 152 of a camera cover 151 can be provided with an air spraying mechanism 156 (an air spraying device in the present invention). The air spraying mechanism 156 includes an air nozzle 153, a tube 154, and an air pump 155 for spraying air onto the glass surface 103a of the cover glass 103. The air spraying mechanism 156 can spray air onto the glass surface 103a of the cover glass 103, while or after the washer fluid is sprayed from the spray opening 11 of the washer nozzle 9 onto the glass surface 103a of the cover glass 103. In such an approach, it is possible to prevent the washer fluid from remaining sticking to the glass surface 103a of the cover glass 103.

The wiping mechanism 125 explained in FIGS. 16A and 16B, the rotating mechanism 135 explained in FIGS. 17A and 17B, the vibrating mechanism 145 explained in FIGS. 18A and 18B, and the air spraying mechanism 156 explained in FIGS. 19A and 19B can be configured to work in accordance with an operating status of a vehicle wiper. The wiping mechanism 125, the rotating mechanism 135, the vibrating mechanism 145, and the air spraying mechanism 156 can operate during a period of time when the vehicle wiper operates. In such an approach, it is possible to prevent raindrops from sticking to the lens surface 5a or the glass surface 103a. Further, even if raindrops stick to the lens surface 5a or the glass surface 103a, the raindrops can be removed.

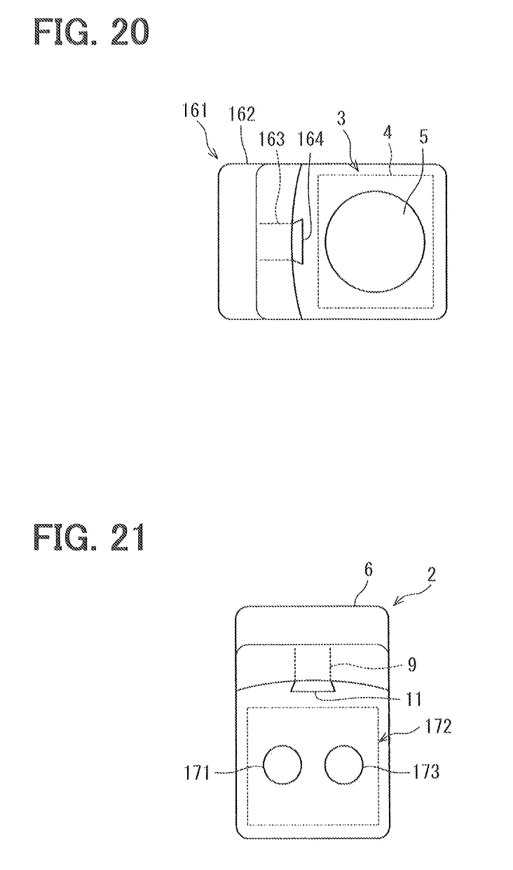

As shown in FIG. 20, a washer nozzle 163 can be located in a casing 162 of a camera cover 161 on the side of the camera 3. The washer fluid stored in the washer fluid tank 15 can be supplied to the washer nozzle 163 through the tube 10, and the washer fluid supplied to the washer nozzle 163 can be splayed from a spray opening 164 onto the lens surface 5a of the lens 5 from the side. In this case, the washer nozzle 163 extends over the entire casing 162 like the washer nozzle 9, which is explained in FIGS. 1A and 1B and extends over the entire casing 6. In such an approach, since the washer nozzle 163 is located on the side of the camera 3, the on-board optical sensor apparatus can be reduced in size in a height direction. It is noted that the on-board optical sensor apparatus may be mounted on the vehicle in a manner shown in FIGS. 1A and 1B or FIG. 20 according to types of vehicles in terms of mounting position limited by vehicle structure and appearance required by vehicle makers. According to this embodiment, the on-board optical sensor apparatus can be vertically or horizontally mounted on the vehicle according to types of vehicles.

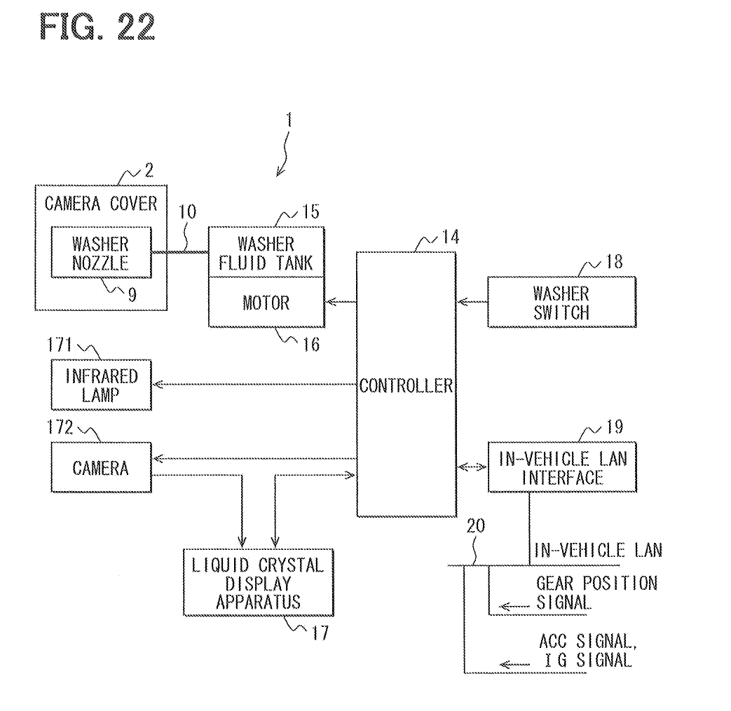

As shown in FIGS. 21 and 22, a camera 172 into which an infrared lamp 171 (a lighting device in the present invention) is integrated can be included. The washer fluid stored in the washer fluid tank 15 can be supplied to the washer nozzle 9 and splayed from the spray opening 11 onto not only a lens surface of a lens 173 of the camera 172 but also the infrared lamp 171. For example, the infrared lamp 171 can be used to assist the ambient brightness, when the camera 3 captures an image at night. According to the embodiment shown in FIGS. 21 and 22, foreign matters sticking to a lens of the infrared lamp 171 are suitably removed so that infrared light can be suitably radiated. Alternatively, in FIGS. 21 and 22, the infrared lamp 171 can be replaced with a visible-light lamp (a lighting device in the present invention). Even the visible-light lamp can produce the same effect as the infrared lamp 171.

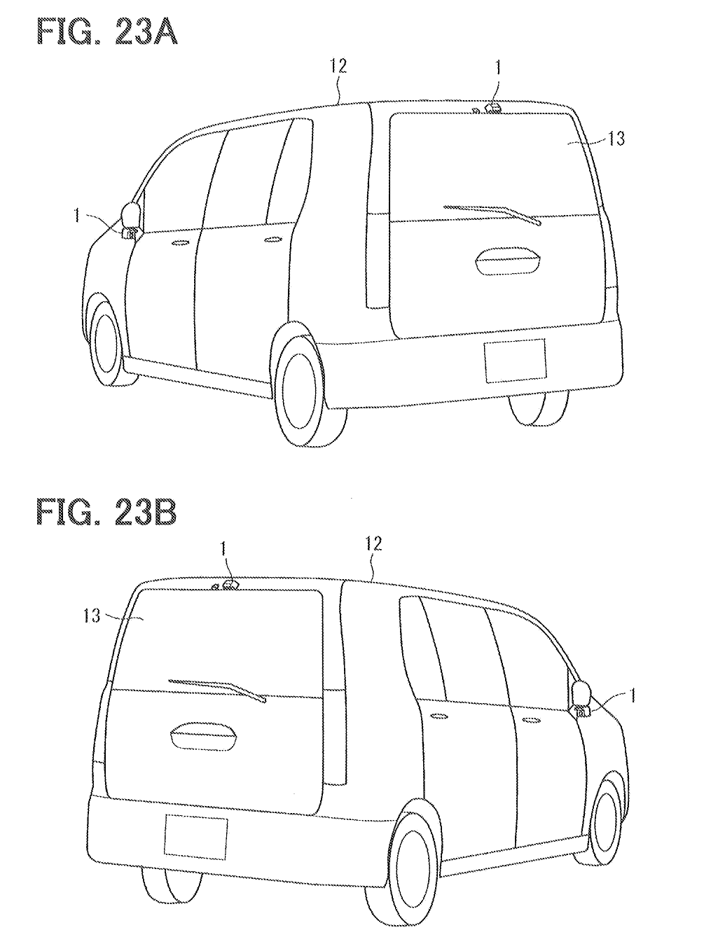

As shown in FIGS. 23A and 23B, the optical sensor unit 1 can be located not only above the rear window 13 of the vehicle body 12 but also below a side mirror attached to the side of the vehicle. In such an approach, the camera 3 can capture an image of the area behind and beside the vehicle. That is, multiple cameras can be mounted.

Any two or more of the above embodiments can be combined together. For example, the pan 63 explained in FIGS. 10A and 10B, the canopy 73 explained in FIGS. 11A and 11B, and the wiping mechanism 125 explained in FIGS. 16A and 16B can be included at the same time.

In the above embodiments, the on-board optical sensor apparatus includes the controller and the optical sensor unit. Alternatively, the camera cover can include the controller.

### Third Embodiment

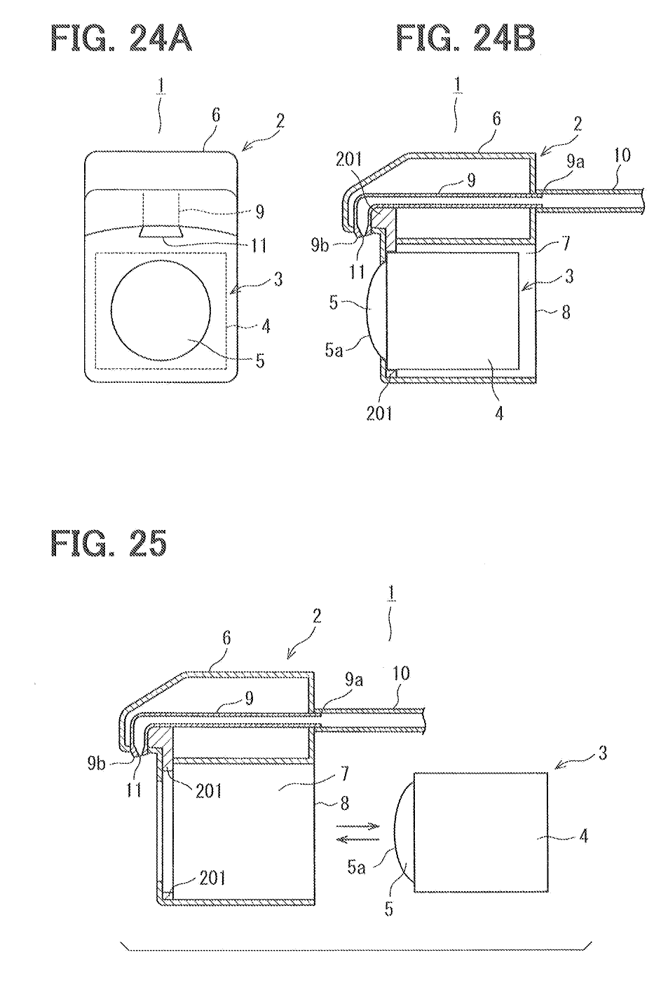

A third embodiment of the present invention is described below with reference to FIGS. 24A-27. The third embodiment differs from the first embodiment in the following points. As shown in FIGS. 24A and 24B, a heater 201 (an optical heating device and a nozzle heating device, which are integrally formed from the same member, in the present invention) and a wire (not shown) for supplying an electric current to the heater 201 are located in the casing 6. In the condition where the camera 3 is normally held in the holder 7, the heater 201 covers the entire side periphery of the lens 5 of the camera 3 and is in contact with a portion (near a curved portion in the present embodiment) of the washer nozzle 9 on the tip end 9b side. For example, the heater 201 can be a mesh of hot wires. Heat generated by the heater 201 is transmitted to the lens 5 of the camera 3 and the portion of the washer nozzle 9 on the tip end 9b side.

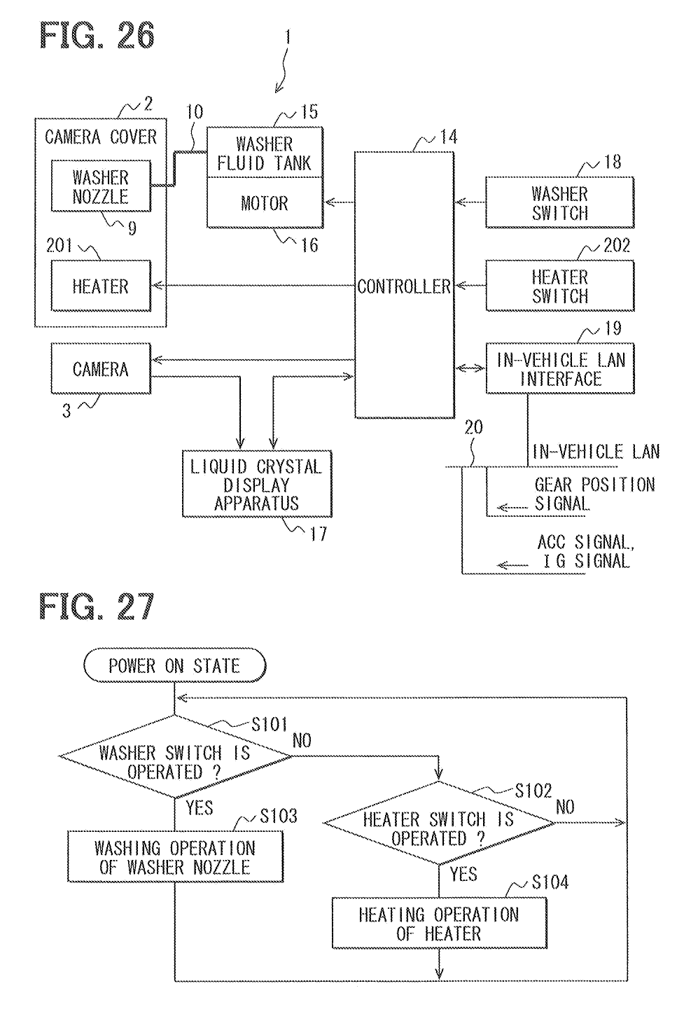

FIG. 26 is a functional block diagram illustrating an electrical configuration of peripheral circuitry including the optical sensor unit 1. The controller 14 mainly includes a microcomputer. The controller 14 executes a prestored control program, thereby controlling the capture operation of the camera 3, controlling a heat operation of the heater 201, and controlling the operation of the motor 16 installed in the washer fluid tank 15 so as to control the washing operation of the washer nozzle 9. A heater switch 202 is operable by a user. When a user operates the heater switch 202, the heater switch 202 outputs an operation detection signal to the controller 14. When receiving the operation detection signal outputted from the heater switch 202, the controller 14 outputs a drive command signal to the heater 201, thereby driving the heater 201. The drive command signal outputted from the controller 14 to the motor 16 and the drive command signal outputted from the controller 14 to the heater 201 are level signals. The washing operation of the washer nozzle 9 and the heat operation of the heater 201 are performed only during a period of time where the level signals are ON (High level). The washer switch 18 and the heater switch 202 can be mechanical switches or touch switches displaced on the liquid crystal display apparatus 17.

An action of the above configuration is described below with reference to FIG. 27.

In a power-ON state (in a driven state of the optical sensor unit 1), the controller 14 determines whether the washer switch 18 is operated (step S101) and determines whether the heater switch 202 is operated (step S102). When the controller 14 receives the operation detection signal outputted from the washer switch 18 and determines that the washer switch 18 is operated (“YES” at step S101), the controller 14 outputs the drive commend signal to the motor 16 to drive the motor 16, thereby performing the washing operation of the washer nozzle 9 (step S103). That is, the washer fluid stored in the washer fluid tank 15 is supplied to the washer nozzle 9 and splayed from the spray opening 11 onto the lens surface 5a of the lens 5 of the camera 3 (step S103). In this case, the controller 14 can continue the washing operation of the washer nozzle 9 only for a predetermined period of time (for example, a few seconds). Alternatively, the controller 14 can continue the washing operation of the washer nozzle 9 only while a user is operating (for example, pressing) the washer switch 18. Further, if a function of measuring the amount of the washer fluid is included, the washing operation of the washer nozzle 9 can be continued only until the amount of the splayed washer fluid reaches a predetermined amount.

Further, when the controller 14 receives the operation detection signal outputted from the heater switch 202 and determines that the heater switch 202 is operated (“YES” at step S102), the controller 14 outputs the drive commend signal to the heater 201 to drive the heater 201, thereby driving the heating operation of the heater 201 (step S104). That is, the heat generated by the heater 201 is transmitted to the entire side periphery of the lens 5 of the camera 3 and also transmitted to the tip end 9b side of the washer nozzle 9. In this case, the controller 14 can continue the heating operation of the heater 201 only for a predetermined period of time. Alternatively, the controller 14 can continue the heating operation of the heater 201 only while a user is operating (for example, pressing) the heater switch 202. The controller 14 repeats the above steps S101-S104.

As described above, according to the third embodiment, the heater 201 can heat not only the lens 5 of the camera 3 but also the washer nozzle 9. Even when the ambient temperature decreases, the lens 5 of the camera 3 can be heated to prevent the lens surface 5a of the lens 5 of the camera 3 from fogging and to prevent water on the lens surface 5a from freezing. Further, the washer nozzle 9 can be heated to prevent the washer fluid from freezing. Thus, the washer fluid can be suitably sprayed onto the lens surface 5a so that foreign matters sticking to the lens surface 5a can be suitably removed. Therefore, the camera 3 can suitably work.

### Fourth Embodiment

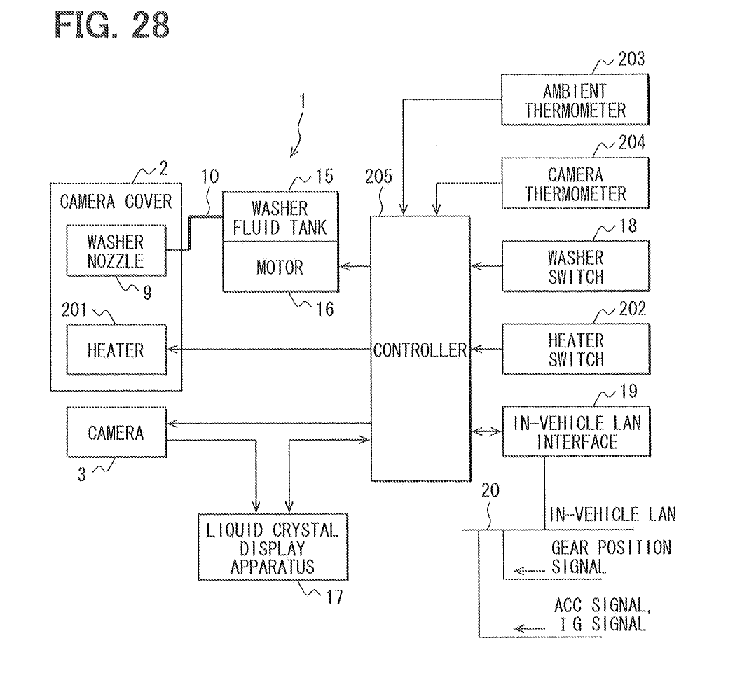

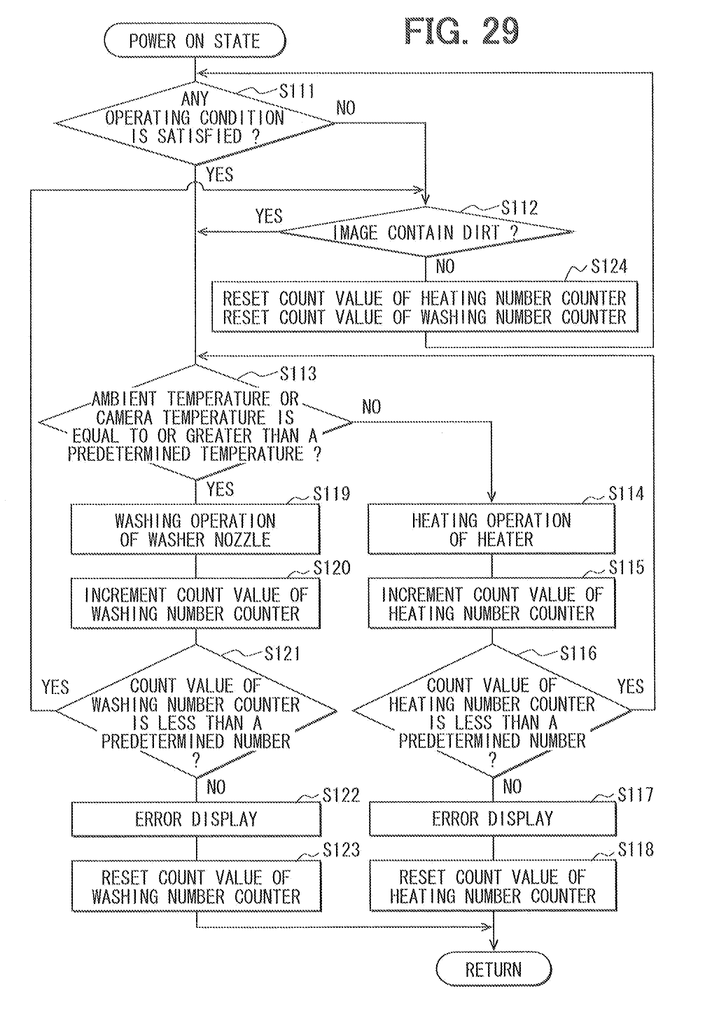

A fourth embodiment of the present invention is described below with reference to FIGS. 28 and 29. The fourth embodiment differs from the third embodiment in the following points.

According to the fourth embodiment, as shown in FIG. 28, an ambient thermometer 203 (an ambient temperature measuring device in the present invention) for measuring an ambient temperature and a camera thermometer 204 (a sensor temperature measuring device in the present invention) for measuring a temperature of the camera 3 are included. When receiving a temperature measurement signal outputted from the ambient thermometer 203, a controller 205 detects the ambient temperature by analyzing the received temperature measurement signal. When receiving a temperature measurement signal outputted from the camera thermometer 204, the controller 205 detects the temperature of the camera 3 by analyzing the received temperature measurement signal. It is noted that the controller 205 has a counting function.

In FIG. 29, in a power-ON state (in a driven state of the optical sensor unit 1), the controller 205 determines whether any of the operating conditions is satisfied (step S111) and determines whether the image contains dirt (step S112). Then, if the controller 205 determines that any of the operating conditions is satisfied, i.e., determines that the gear is shifted into the reverse position, the IG switch is switched from the OFF state to the ON state, or the IG switch is switched from the ON state to the OFF state (“YES” at step S111), or if the controller 205 determines that the image contains dirt (“YES” at step S112), the controller 205 determines whether the ambient temperature or the temperature of the camera 3 is equal to or greater than a predetermined temperature (step S113).

Then, if the controller 205 determines that the ambient temperature or the temperature of the camera 3 is less than the predetermined temperature (“NO” at step S113), the controller 205 drives the heater 201 so as to perform the heating operation of the heater 201 only for a predetermined period of time (step S114). Then, the controller 205 increments (addition of “1”) a heating number counter (step S115) and determines whether a value of the incremented heating number counter is less than a predetermined number (step S116). If the controller 205 determines that the value of the incremented heating number counter is less than the predetermined number (“YES” at step S116), the controller 205 returns to step S113 and repeats the steps subsequent to step S113. In contrast, if the controller 205 determines that the value of the incremented heating number counter is equal to or greater than the predetermined number (“NO” at step S116), the controller 205 causes the liquid crystal display apparatus 17 to display an error display indicating that the heating operation of the heater 201 was repeated the predetermined number of times (step S117). Then, the controller 205 resets the value of the heating number counter (step S118) and finishes the series of procedures.

If the controller 205 determines that the ambient temperature or the temperature of the camera 3 is equal to or greater than the predetermined temperature (“YES” at step S113), the controller 205 drives the motor 16 so as to perform the washing operation of the washer nozzle 9 for a predetermined period of time (step S119). Then, the controller 205 increments (addition of “1”) a washing number counter (step S120) and determines whether a value of the incremented washing number counter is less than a predetermined number (step S21). If the controller 205 determines that the value of the incremented washing number counter is less than the predetermined number (“YES” at step S121), the controller 205 returns to step S112 and repeats the steps subsequent to step S112. In contrast, if the controller 205 determines that the value of the incremented washing number counter is equal to or greater than the predetermined number (“NO” at step S121), the controller 205 causes the liquid crystal display apparatus 17 to display an error display indicating that the washing operation of the washer nozzle 9 was performed the predetermined number of times (step S122). Then, the controller 205 resets the value of the washing number counter (step S123) and finishes the series of procedures.

If the controller 205 determines that the image contains no dirt (dirt is removed as a result of the washing operation of the washer nozzle 9) (“NO” at step S112), the controller 205 resets not only the value of the heating number counter but also the value of the washing number counter (step S124) and returns to step S11 and repeats the steps subsequent to step S111.

As described above, according to the fourth embodiment, the lens surface 5a of the lens 5 of the camera 3 can be automatically washed whenever it is detected that the gear of the vehicle is shifted into the reverse position, the IG switch is switched from the OFF state to the ON state, the IG switch is switched from the ON state to the OFF state, or the image contains dirt. Further, the error display is displayed when the value of the heating number counter or the washing number counter becomes equal to or greater than the predetermined number. Alternatively, if a function of measuring the heating time or the washing time is included, the error display can be displayed when the heating time or the washing time reaches a predetermined time.

(Modifications)

The above embodiment can be modified and extended as follows. A heater for heating the lens 5 of the camera 3 can be provided separately from a heater for heating the washer nozzle 9.

In the embodiment, the heater 201 is configured to heat both the lens 5 of the camera 3 and the washer nozzle 9 by itself. Alternatively, the heater 201 can be configured to heat any one of the lens 5 of the camera 3 and the washer nozzle 9.

Assuming that the heater 201 is configured to heat the lens 5 of the camera 3, the lens 5 of the camera 3 is heated by the heater 201 upon decrease in ambient temperature so as to prevent the lens surface 5a of the lens 5 of the camera 3 from fogging. Therefore, the camera 3 can suitably work so as to capture a suitable image of the subject.

Assuming that the heater 201 is configured to heat the washer nozzle 9, the washer nozzle 9 is heated by the heater 201 upon decrease in ambient temperature so as to prevent the washer fluid from freezing. Thus, the washer fluid can be suitably sprayed onto the lens surface 5a so that foreign matters sticking to the lens surface 5a can be suitably removed. Therefore, the camera 3 can suitably work so as to capture a suitable image of the subject.

In the embodiment, the error display is displayed on the liquid crystal display apparatus 17 when the value of the heating number counter or the washing number counter becomes equal to or greater than the predetermined number. Alternatively, in such a case, an error surround can be outputted from a speaker, or vibration or static electricity can be generated from a seat or a handle by a static electricity generator or a vibration generator mounted to the seat or the handle. Alternatively, these can be used in combination with each other. That is, reporting can be performed through any of the sense of sight, the sense of hearing, and the sense of touch.

The configuration shown in FIG. 27 in which the washing operation of the washer nozzle 9 is manually performed can be used in combination with the configuration shown in FIG. 29 in which the washing operation of the washer nozzle 9 is automatically performed.

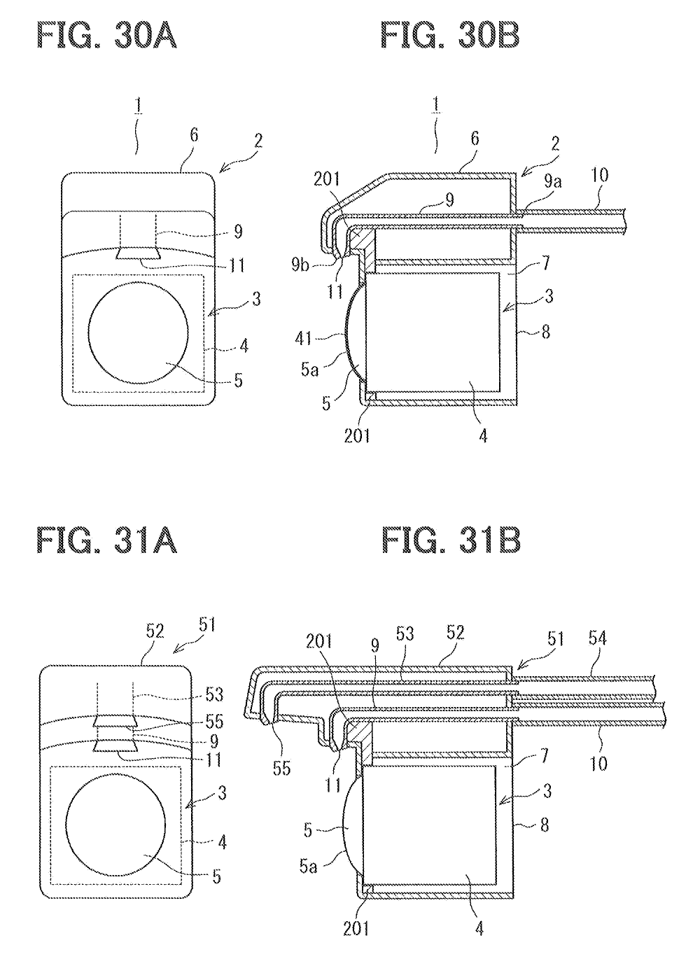

As shown in FIGS. 30A and 30B, like the configuration shown in FIGS. 8A and 8B, even when the heater 201 is included, a water-repellent treatment can be applied to the lens surface 5a of the lens 5 of the camera 3 so that the lens surface 5a can be coated with the water-repellent layer 41. Alternatively, a hydrophilic treatment, a photocatalytic treatment, or an antifouling treatment can be applied to the lens surface 5a so that the lens surface 5a can be coated with a hydrophilic layer, a photocatalytic layer, or an antifouling layer.

As shown in FIGS. 31A and 31B, like the configuration shown in FIGS. 9A and 9B, even when the heater 201 is included, the casing 52 of the camera cover 51 can be provided with the window washer nozzle 53 that is arranged parallel to the washer nozzle 9. The washer fluid stored in the washer fluid tank 15 can be supplied to the window washer nozzle 53 through the tube 54, and the washer fluid supplied to the window washer nozzle 53 can be splayed from the spray opening 55 onto the window.

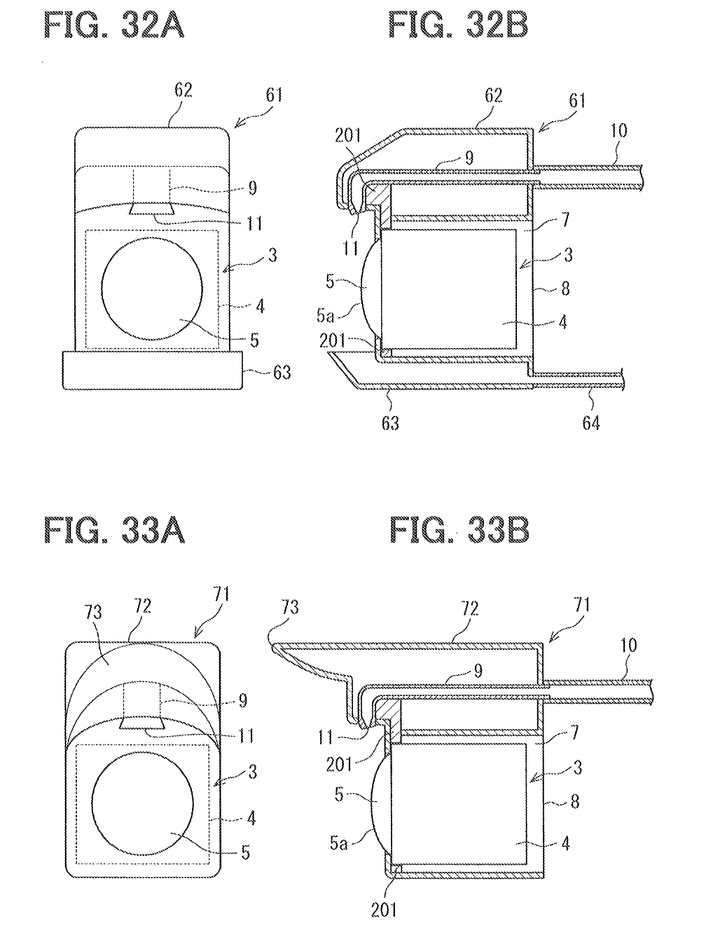

As shown in FIGS. 32A and 32B, like the configuration shown in FIGS. 10A and 10B, even when the heater 201 is included, the casing 62 of the camera cover 61 can be provided the pan 63 and the tube 64. When the washer fluid is sprayed from the splay opening 11 of the washer nozzle 9 onto the lens surface 5a of the lens 5 of the camera 3, the pan 63 can catch the washer fluid dripping from the lens surface 5a, and the washer fluid caught by the pan 63 can be drained through the tube 64.

As shown in FIGS. 33A and 33B, like the configuration shown in FIGS. 11A and 11B, even when the heater 201 is included, the casing 72 of the camera cover 71 can be provided with the canopy 73.

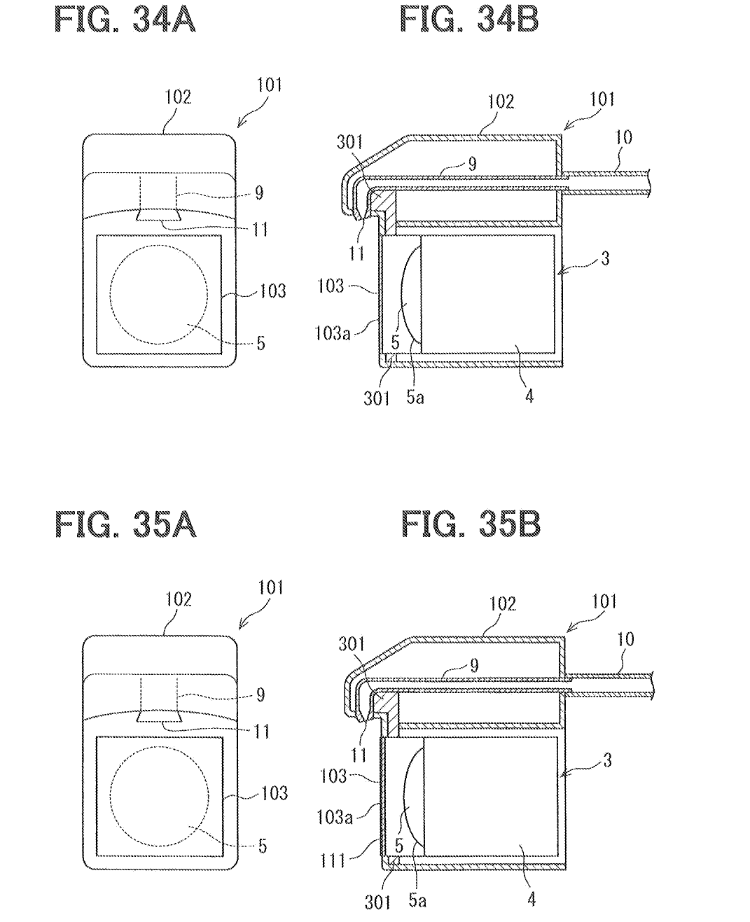

As shown in FIGS. 34A and 34B, like the configuration shown in FIGS. 14A and 14B, even when the heater 201 is included, the casing 102 of the camera cover 101 can be provided with the transparent cover glass 103. The cover glass 103 can be located on the front side of the casing 102 so as to face the lens 5 of the camera 3. The washer fluid supplied from the washer fluid tank 15 to the washer nozzle 9 through the tube 10 can be splayed from the spray opening 11 onto the glass surface 103a of the cover glass 103.

In this case, a heater 301 covers the entire side periphery of the cover glass 103 and is in contact with the portion of the washer nozzle 9 on the tip end 9b side. Heat generated by the heater 301 can be transmitted to the cover glass 103 and the portion of the washer nozzle 9 on the tip end 9b side. Further, since the entire camera 3 is held in the casing 102, a size of the casing 102 in a front-rear direction (from a front side to a rear side) of the casing 102 is greater than a size of the casing 6 of the third embodiment. In such an approach, while the cover glass 103 protects the lens 5 of the camera 3, the glass surface 103a of the cover glass 103 can be prevented from fogging. Further, the washer fluid can be prevented from freezing. Thus, the washer fluid can be suitably sprayed onto the glass surface 103a so that foreign matters stickling to the glass surface 103a can be suitably removed. Therefore, the camera 3 can suitably work so as to capture a suitable image of the subject.

As shown in FIGS. 35A and 35B, like the configuration shown in FIGS. 15A and 15B, even when the heater 301 is included, a water-repellent treatment can be applied to the glass surface 103a of the cover glass 103 so that the glass surface 103a can be coated with the water-repellent layer 111. Alternatively, a hydrophilic treatment, a photocatalytic treatment, or an antifouling treatment can be applied to the glass surface 103a so that the glass surface 103a can be coated with a hydrophilic layer, a photocatalytic layer, or an antifouling layer.

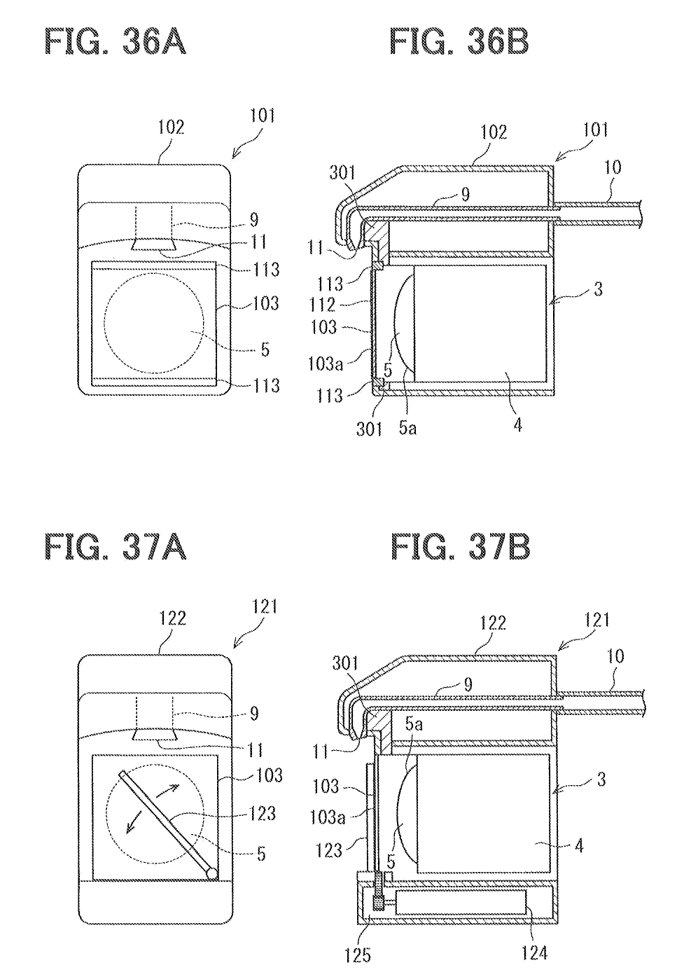

As shown in FIGS. 36A and 36B, in the casing 102 of the camera cover 101, the glass surface 103a of the cover glass 103 can be coated with indium tin oxide 112, and an electrode 113 can be provided on a top side portion and a bottom side portion of the cover glass 103. A predetermined voltage can be applied to the electrode 113 so that an electric current can flow through the indium tin oxide 112. As a result, the indium tin oxide 112 generates heat so that the cover glass 103 can be heated. Alternatively, the lens surface 5a of the lens 5 of the camera 3 can be coated with indium tin oxide, and an electrode provided in the camera 3 can cause the indium tin oxide to generate heat so that the lens 5 can be heated.

As shown in FIGS. 37A and 37B, like the configuration shown in FIGS. 16A and 16B, even when the heater 301 is included, the casing 122 of the camera cover 121 can be provided with the wiping mechanism 125 including the wiper 123 for wiping the glass surface 103a of the cover glass 103 and the motor 124 for driving the wiper 123. The wiping mechanism 125 can wipe the glass surface 103a of the cover glass 103, while or after the washer fluid is sprayed from the spray opening 11 of the washer nozzle 9 onto the glass surface 103a of the cover glass 103.

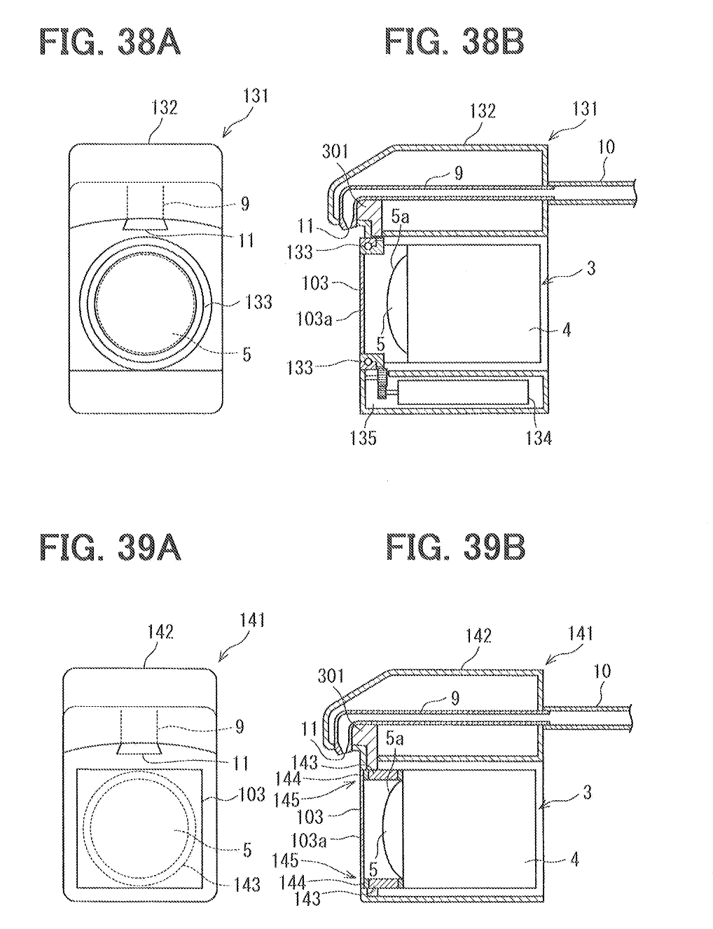

As shown in FIGS. 38A and 38B, like the configuration shown in FIGS. 17A and 17B, even when the heater 301 is included, the casing 132 of the camera cover 131 can be provided with the rotating mechanism 135 including the sealed bearing 133 and the motor 134 for causing the cover glass 103 to rotate. The rotating mechanism 135 can cause the cover glass 103 to rotate, while or after the washer fluid is sprayed from the spray opening 11 of the washer nozzle 9 onto the glass surface 103a of the cover glass 103.

As shown in FIGS. 39A and 39B, like the configuration shown in FIGS. 18A and 18B, even when the heater 301 is included, the casing 142 of the camera cover 141 can be provided with the vibrating mechanism 145 including the piezoelectric device 143 and the electrode 144 for generating ultrasonic wave or subsonic wave that causes the cover glass 103 to vibrate. The vibrating mechanism 145 can cause the cover glass 103 to vibrate, while or after the washer fluid is sprayed from the spray opening 11 of the washer nozzle 9 onto the glass surface 103a of the cover glass 103.

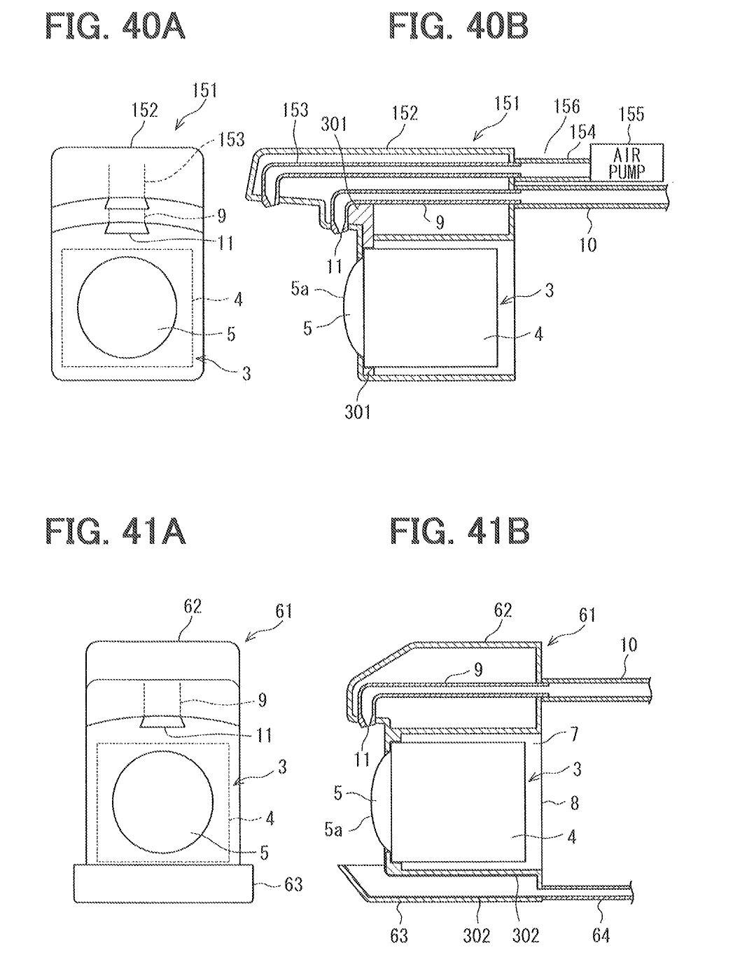

As shown in FIGS. 40A and 40B, like the configuration shown in FIGS. 19A and 19B, even when the heater 301 is included, the casing 152 of the camera cover 151 can be provided with the air spraying mechanism 156 including the air nozzle 153, the tube 154, and the air pump 155 for spraying air onto the glass surface 103a of the cover glass 103. The air spraying mechanism 156 can spray air onto the glass surface 103a of the cover glass 103, while or after the washer fluid is sprayed from the spray opening 11 of the washer nozzle 9 onto the glass surface 103a of the cover glass 103.

The wiping mechanism 125 explained in FIGS. 37A and 37B, the rotating mechanism 135 explained in FIGS. 38A and 38B, the vibrating mechanism 145 explained in FIGS. 39A and 39B, and the air spraying mechanism 156 explained in FIGS. 40A and 40B can be configured to work in accordance with an operating status of the vehicle wiper. The wiping mechanism 125, the rotating mechanism 135, the vibrating mechanism 145, and the air spraying mechanism 156 can operate during a period of time when the vehicle wiper operates.

Any two or more of the above embodiments can be combined together. For example, the pan 63 explained in FIGS. 32A and 32B, the canopy 73 explained in FIGS. 33A and 33B, and the wiping mechanism 125 explained in FIGS. 37A and 37B can be included at the same time.

As shown in FIGS. 41A and 41B, when the pan 63 is included, a heater 302 (a pan heating device in the present invention) for heating the pan 63 can be included. In such an approach, it is possible to prevent the water fluid, dripping from the lens surface 5a and collecting in the pan 63, from freezing. Thus, the water fluid collecting in the pan 63 can be smoothly discharged. For example, the heater 302 can be a mesh of hot wires.

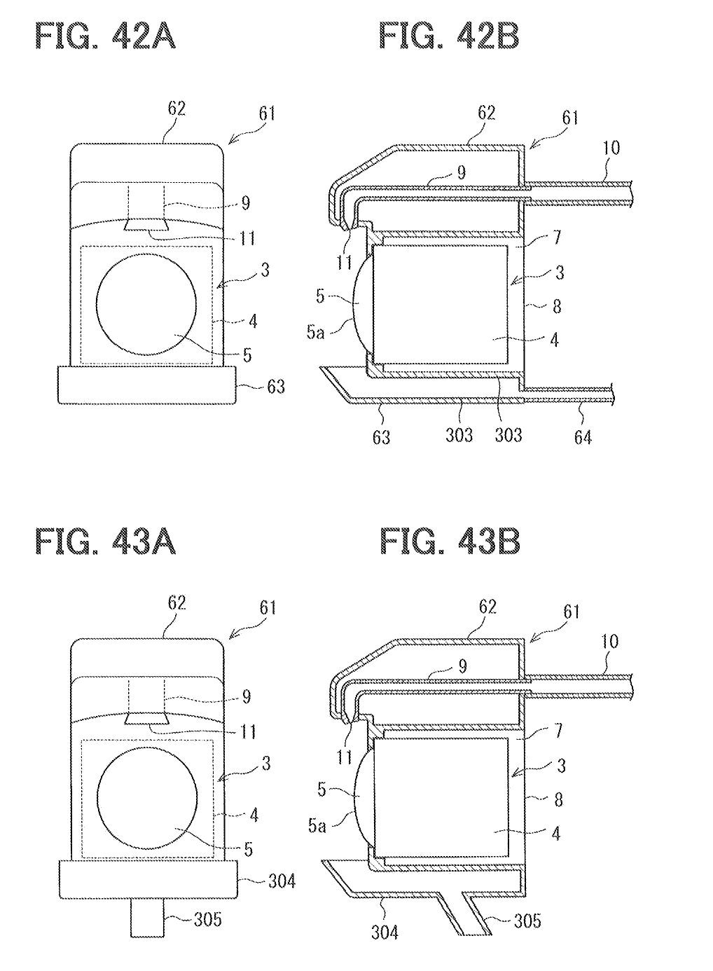

As shown in FIGS. 42A and 42B, when the pan 63 is included, a water-repellent treatment can be applied to a contact surface in contact with the washer fluid so that the contact surface can be coated with a water-repellent layer 303. Alternatively, a hydrophilic treatment can be applied to the contact surface so that the contact surface can be coated with a hydrophilic layer. In such an approach, the water fluid, dripping from the lens surface 5a and collecting in the pan 63, can be smoothly discharged.

As shown in FIGS. 43A and 43B, when the pan 63 is included, a path 305 for guiding the water fluid collecting in the pan 63 to the window can be included. In such an approach, the washer fluid collecting in the pan 63 is recycled to wash the window and thus effectively used without being wasted.

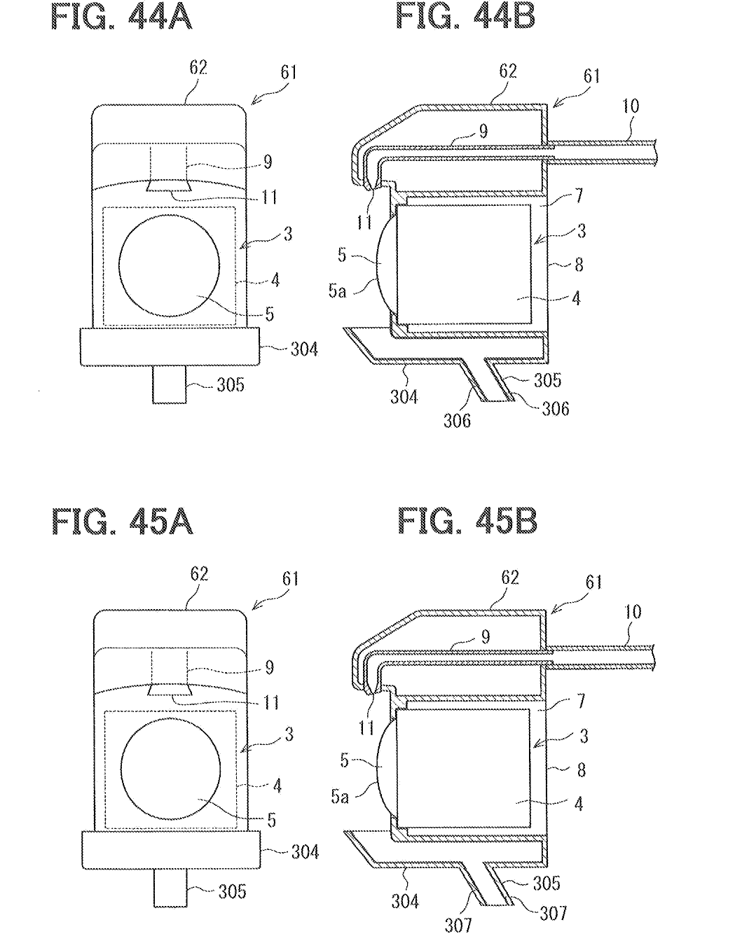

As shown in FIGS. 44A and 44B, a path heater 306 (a path heating device in the present invention) for heating the path 305 can be included. In such an approach, it is possible to prevent the water fluid guided to the path 305 from freezing. Thus, the water fluid guided to the path 305 can be smoothly discharged. For example, the path heater 306 can be a mesh of hot wires.

As shown in FIGS. 45A and 45B, when the path 305 is included, a water-repellent treatment can be applied to a contact surface in contact with the washer fluid so that the contact surface can be coated with a water-repellent layer 307. Alternatively, a hydrophilic treatment can be applied to the contact surface so that the contact surface can be coated with a hydrophilic layer. In such an approach, the water fluid guided to the path 305 can be smoothly discharged.

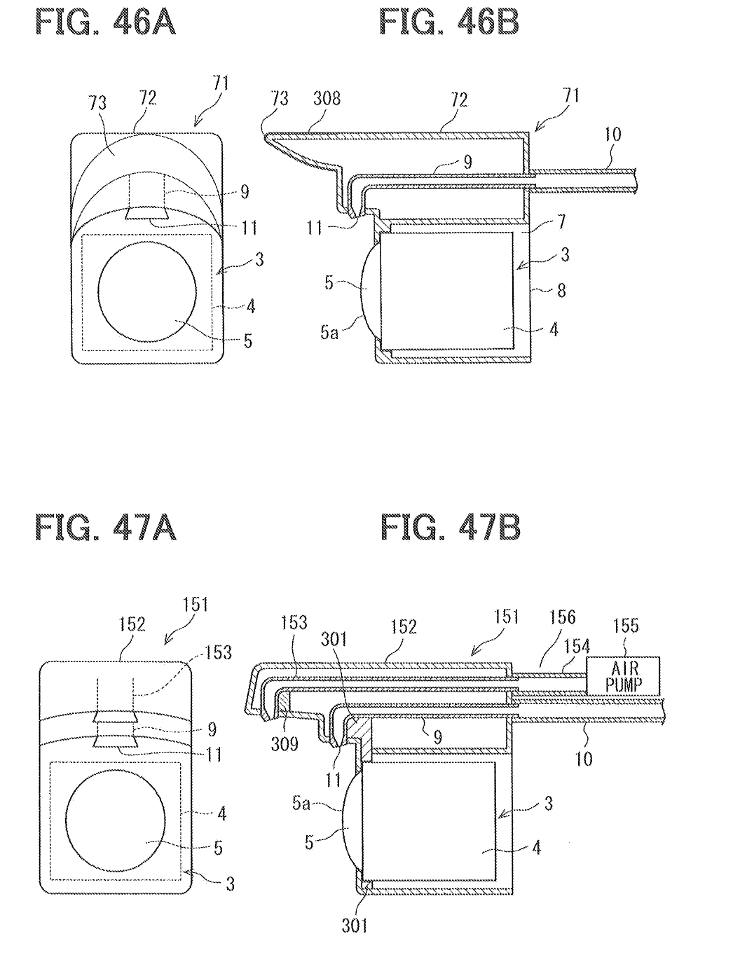

As shown in FIGS. 46A and 46B, when the canopy 73, projecting from the casing 72 and covering the lens surface 5a from above, is included, a canopy heater 308 (a canopy heating device in the present invention) for heating the canopy 73 can be included. In such an approach, it becomes less likely that snow and ice accumulate on the canopy 73. Further, even when snow and ice accumulate on the canopy 73, the accumulating snow and ice can be melted and removed to prevent the snow and ice from blocking the view of the optical sensor. For example, the canopy heater 308 can be a mesh of hot wires. The canopy heater 308 can be provided on each of a top side and a bottom side of the canopy 73. Alternatively, the canopy heater 308 can be provided on only the top side of the canopy 73.

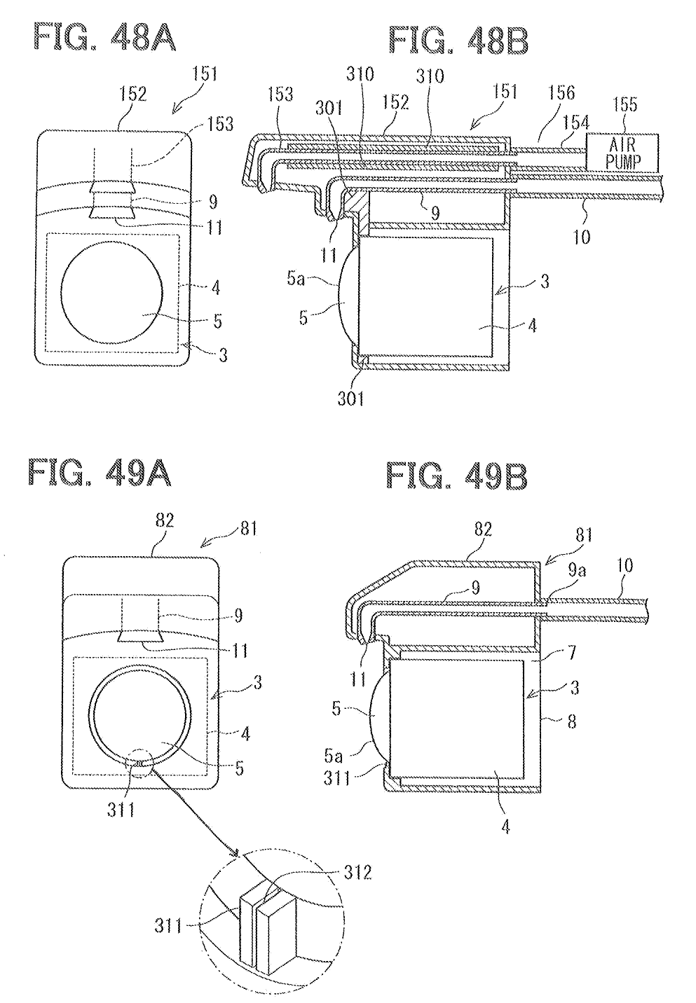

As shown in FIGS. 47A and 47B, when the air spraying mechanism 156 is included, an air heater 309 (an air heating device in the present invention) for heating air sprayed from the tip portion of the air nozzle 153 can be included. Alternatively, as shown in FIGS. 48A and 48B, when the air spraying mechanism 156 is included, an air nozzle heater 310 (an air spraying device heating device in the present invention) for heating the air nozzle 153 can be included. In such an approach, even if the washer fluid freezes to the lens surface 5a, the washer fluid freezing to the lens surface 5a can be removed. It is noted that the air heater 309 and the air nozzle heater 310 can be used in combination with each other.

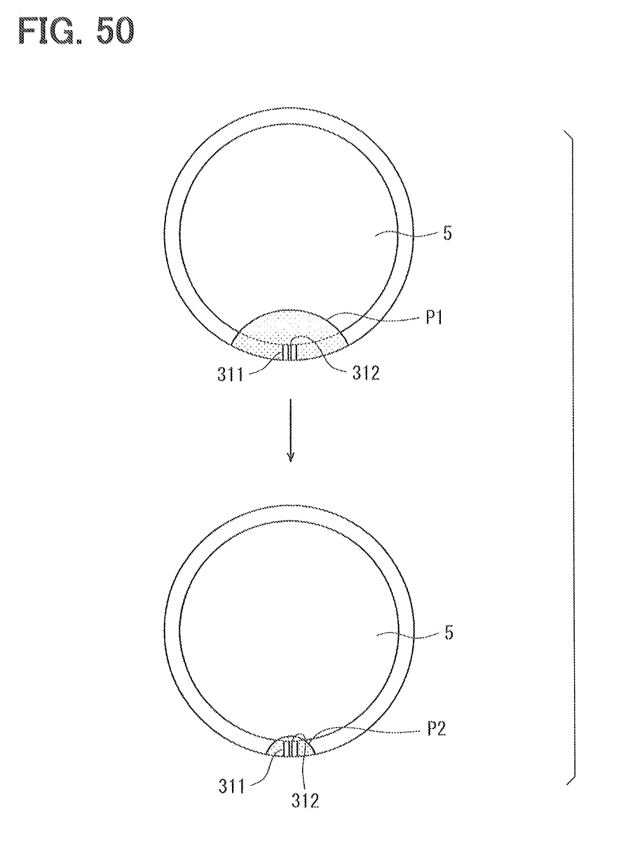

As shown in FIGS. 49A and 49B, when the casing 82 of the camera cover 81 is provided with a projection 311 that is located at a position (directly below the lens 5) near the bottom edge of the lens surface 5a of the lens 5 of the camera 3, the projection 311 can have a clearance portion 312 extending in up and down directions. In such an approach, as shown in FIG. 50, capillary action occurs in the clearance portion 312 so that the water accumulating in the bottom edge of the lens surface 5a can be surely guided below the lens surface 5a through the clearance portion 312 and thus removed. That is, even when water accumulates in the bottom edge of the lens surface 5a, part of the water flows out due to capillary action so that the amount of the water accumulating in the bottom edge of the lens surface 5a can be reduced (in the case of FIG. 50, the amount is reduced from “P1” to “P2”).

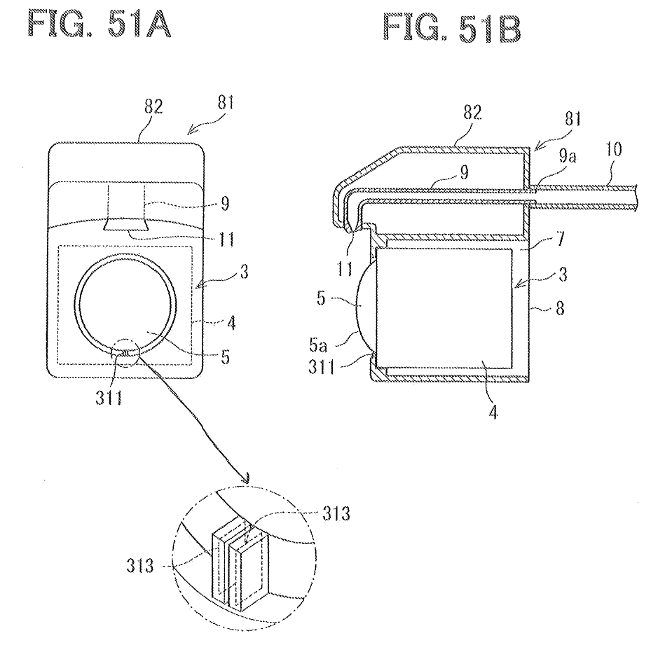

As shown in FIGS. 51A and 51B, the projection 311 can be provided with a projection heater 313 (a projection heating device in the present invention). In such an approach, it is possible to prevent the water left on the projection 311 from freezing.

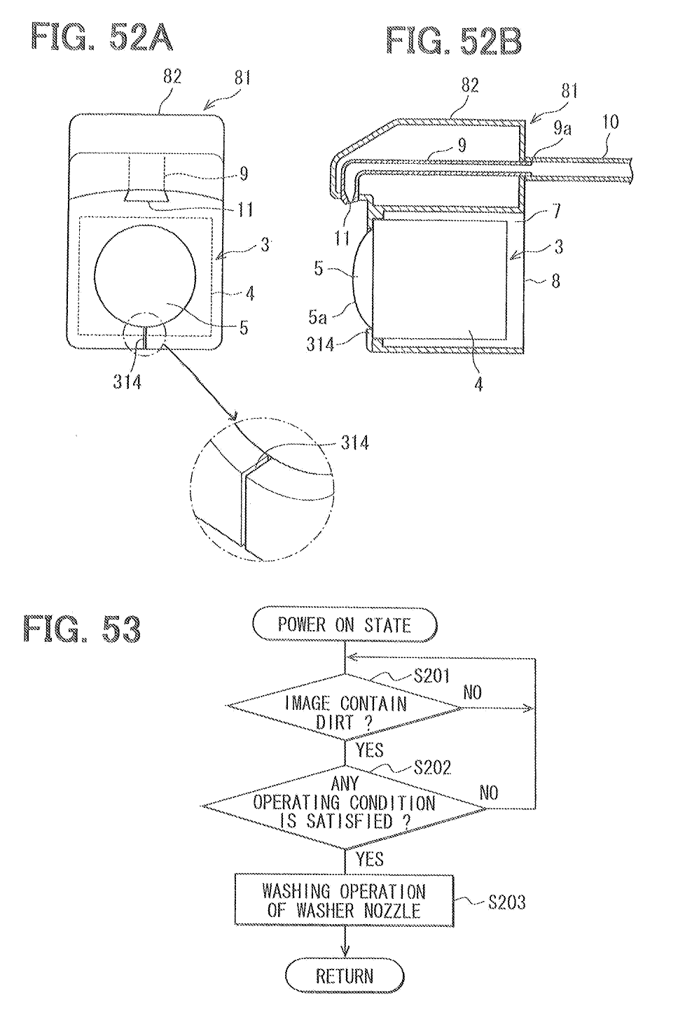

As shown in FIGS. 52A and 52B, the casing 82 of the camera cover 81 can be provided with a slit portion 314 that is located at a position (directly below the lens 5) near the bottom edge of the lens surface 5a of the lens 5 of the camera 3. In such an approach, capillary action occurs in the slit portion 314 so that the water accumulating in the bottom edge of the lens surface 5a can be surely guided below the lens surface 5a through the slit portion 314 and thus removed.

As shown in FIG. 53, if it is determined that the image contains dirt (“YES” at step S201), the washer nozzle can perform the washing operation for a predetermined time period (step S203) upon satisfaction of any of the following operation conditions (“YES” at step S202): the gear of the vehicle is shifted into the reverse position, the IG switch is switched from the OFF state to the ON state, and the IG switch is switched from the ON state to the OFF state. Thus, the washing operation is not performed immediately after the dirt is detected. Since the washing operation is performed at a time when a use is likely to see the image, the washer fluid can be effectively used.

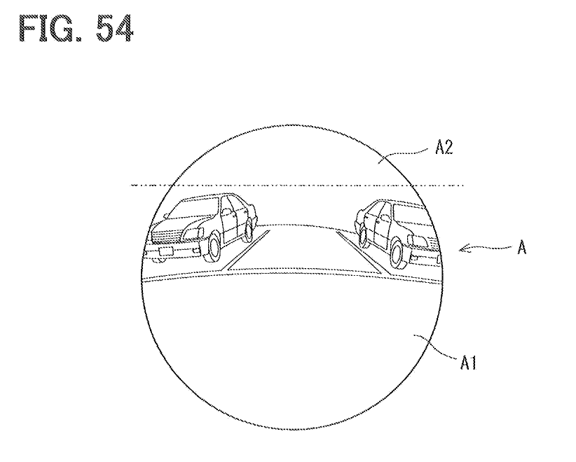

A region of the image captured by the optical sensor, which is supplied to a user, i.e., displayed on the display apparatus in the vehicle compartment, can be analyzed to detect whether the image contains dirt without analyzing another region of the image, which is not supplied to the user. That is, in the case of FIG. 54, an image A1 of an image A captured by the optical sensor corresponds to a bottom side of the fisheye lens 5 and is a region that is supplied to a user, and an image A2 of the image A captured by the optical sensor corresponds to a top side of the fisheye lens 5 and is a region that is not supplied to a user. In this case, it is detected whether the image A1 corresponding to the bottom side of the fisheye lens 5 contains the dirt. In such an approach, the necessary image A1 can be analyzed without additional analysis of the unnecessary image A2.

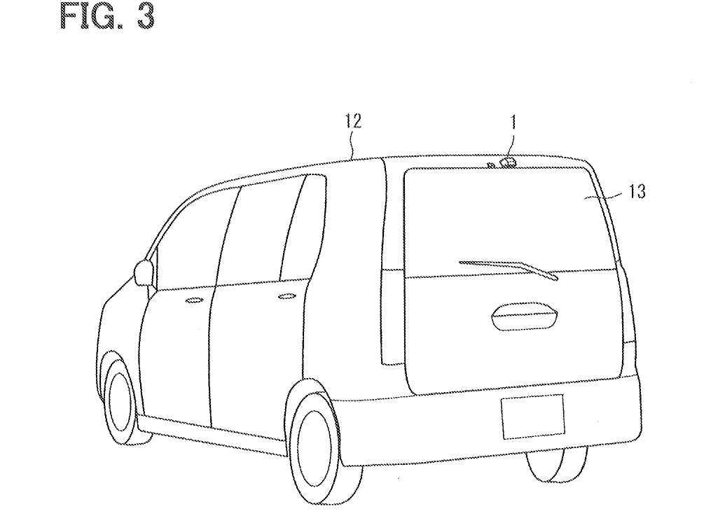

It is noted that the on-board optical sensor cover according to the embodiments can be mounted above a vehicle window, for example, as shown in FIG. 3. In such an approach, the washer nozzle 9 can perform the washing operation not only to wash the lens surface 5a or the glass surface 103a by spraying the washer fluid onto the lens surface 5a or the glass surface 103a, but also to wash the vehicle window by recycling the washer fluid dripping from the lens surface 5a or the glass surface 103a.

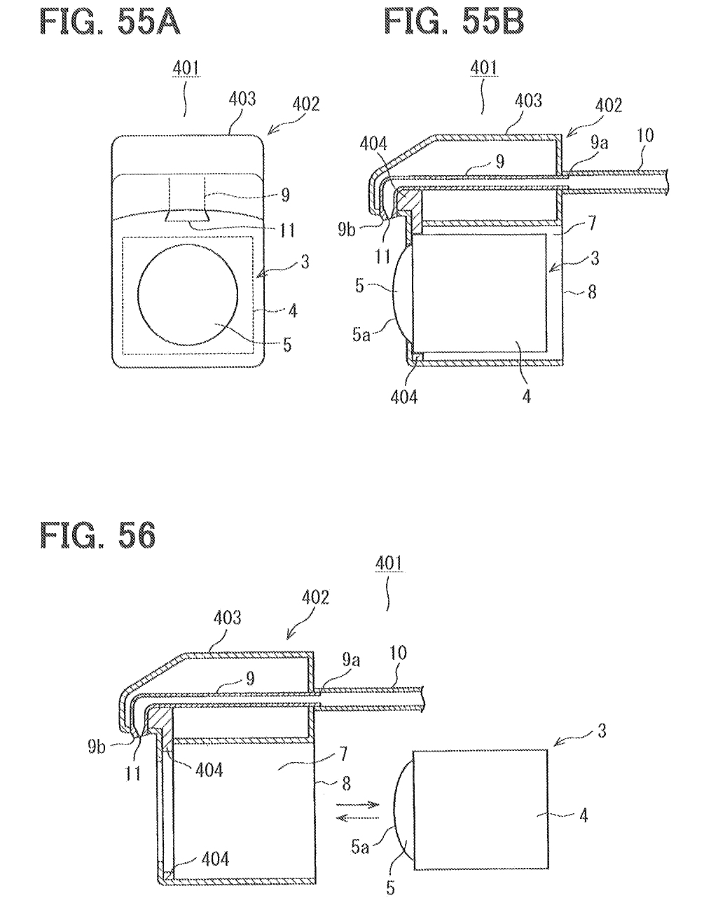

An optical sensor unit 401 according to another modification is described below with reference to FIGS. 55A-60B. As shown in FIGS. 55A, 55B, and 56, a heater 404 and a wire (not shown) for supplying an electric current to the heater 404 are located in the casing 403. In the condition where the camera 3 is normally held in the holder 7, the heater 404 covers the entire side periphery of the lens 5 of the camera 3 and is in contact with a portion (near a curved portion in the present modification) of the washer nozzle 9 on the tip end 9b side. For example, the heater 404 can be a mesh of hot wires. Heat generated by the heater 404 is transmitted to the lens 5 of the camera 3 and the portion of the washer nozzle 9 on the tip end 9b side.

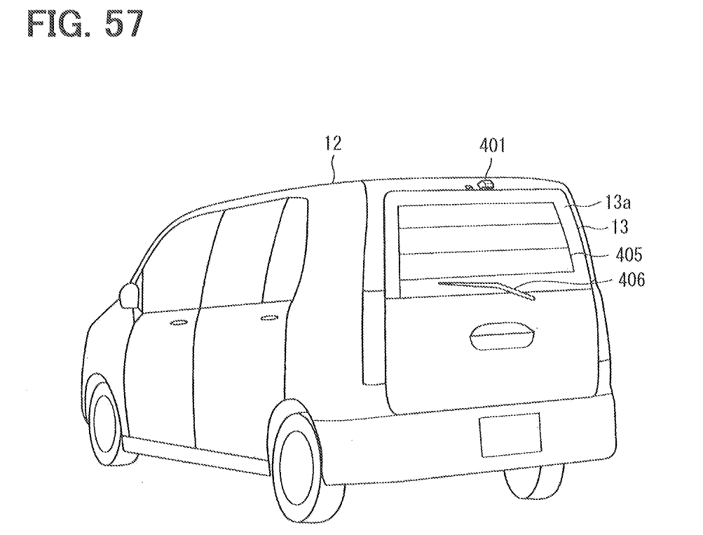

For example, as shown in FIG. 57, the optical sensor unit 401 can be mounted above the rear window 13 outside the vehicle body 12. A defogger wire 405 is attached on the rear window 13 so that heat generated by the defogger wire 405 can be transmitted to the rear window 13. The vehicle body 12 is equipped with a rear wiper 406 for wiping a window surface 13a of the rear window 13. The rear wiper 406 has a rubber member (e.g., rubber blade) in contact with the window surface 13a. The rear wiper 406 is pivotally mounted to the vehicle body 12 below the rear window 13 and reciprocally rotates through a predetermined angle. Thus, the rubber member slides over the window surface 13a so that foreign matters, such as water and dust, sticking to the window surface 13a can be removed.

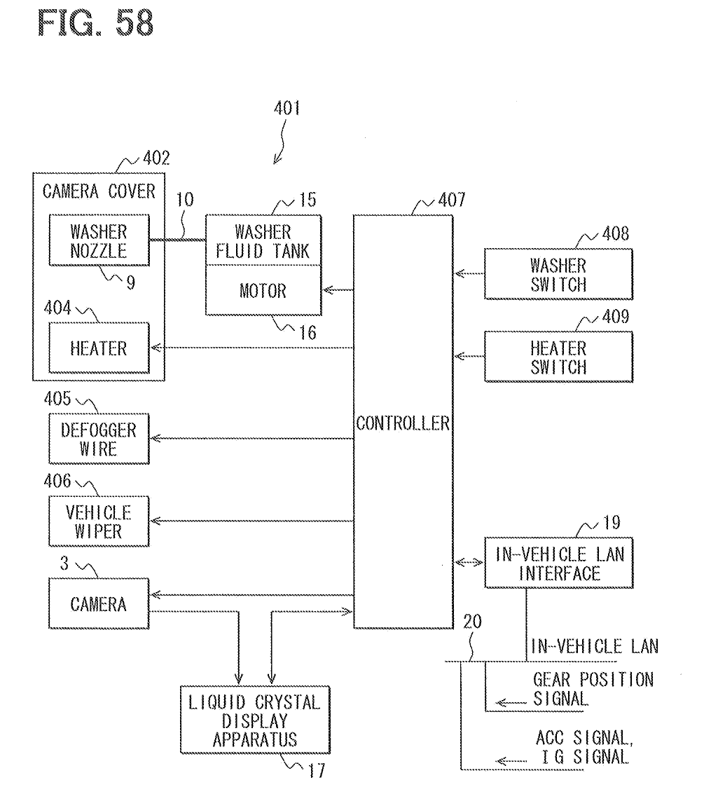

FIG. 58 is a functional block diagram illustrating an electrical configuration of peripheral circuitry including the optical sensor unit 401. A controller 407 mainly includes a microcomputer. The controller 407 executes a prestored control program, thereby controlling the capture operation of the camera 3, controlling a heat operation of the heater 404, and controlling the operation of the motor 16 installed in the washer fluid tank 15 so as to control the washing operation of the washer nozzle 9. A heater switch 402 is operable by a user. In addition, the controller 407 controls a washing operation of the rear wiper 406 to wash the window surface 13a and controls a heat operation of the defogger wire 405 to heat the rear window 13 (i.e., window surface 13a).

A washer switch 408 is operable by a user. When a user operates the washer switch 408, the washer switch 408 outputs an operation detection signal to the controller 407. When receiving the operation detection signal outputted from the washer switch 408, the controller 407 outputs a first drive command signal to the motor 16 and a second drive command signal to the rear wiper 406 (i.e., a motor (not shown) for driving the rear wiper 406), thereby driving the motor 16 and the rear wiper 406. For example, the first drive command signal outputted from the controller 407 to the motor 16 is a level signal, and the washing operation of the washer nozzle 9 to wash the lens surface 5a is performed only during a period of time where the level signal is ON (high level). For example, the second drive command signal outputted from the controller 407 to the motor 16 is a level signal, and the washing operation of the rear wiper 406 to wash the window surface 13a is performed only during a period of time where the level signal is ON (high level). The washer switch 408 can be a mechanical switch or a touch switch displaced on the liquid crystal display apparatus 17.

A heater switch 409 is operable by a user. When a user operates the heater switch 409, the heater switch 409 outputs an operation detection signal to the controller 407. When receiving the operation detection signal outputted from the heater switch 409, the controller 407 outputs a third drive command signal to the heater 404 and a fourth drive command signal to the defogger wire 405, thereby driving the heater 404 and the defogger wire 405 (i.e., energize the defogger wire 405 so that the defogger wire 405 can generate heat). For example, the third drive command signal outputted from the controller 407 to the heater 404 is a level signal, and the heat operation of the heater 404 to heat the lens surface 5a and the washer nozzle 9 is performed only during a period of time where the level signal is ON (High level). For example, the fourth drive command signal outputted from the controller 407 to the defogger wire 405 is a level signal, and the heat operation of the defogger wire 405 to heat the window surface 5a is performed only during a period of time where the level signal is ON (High level). The heater switch 409 can be a mechanical switch or a touch switch displaced on the liquid crystal display apparatus 17.

In a power-ON state (in a driven state of the optical sensor unit 401), the controller 407 determines whether the washer switch 408 is operated (step S21) and determines whether the heater switch 409 is operated (step S22). When the controller 407 receives the operation detection signal outputted from the washer switch 408 and determines that the washer switch 408 is operated (“YES” at step S21), the controller 407 outputs the first drive commend signal to the motor 16 to drive the motor 16, thereby performing the washing operation of the washer nozzle 9 (step S103) to wash the lens surface 5a.

That is, the washer fluid stored in the washer fluid tank 16 is supplied to the washer nozzle 9 and splayed from the spray opening 11 onto the lens surface 5a of the lens 5 of the camera 3. In this case, the controller 407 can continue the washing operation of the washer nozzle 9 only for a predetermined period of time (for example, a few seconds). Alternatively, the controller 407 can continue the washing operation of the washer nozzle 9 only while a user is operating (for example, pressing) the washer switch 18. Further, if a function of measuring the amount of the washer fluid is included, the washing operation of the washer nozzle 9 can be continued only until the amount of the splayed washer fluid reaches a predetermined amount. As a result of the washing operation of the washer nozzle 9, the lens surface 5a is washed so that foreign matters sticking to the lens surface 5a can be removed.

Then, the controller 407 starts measuring time (step S25) by using a timer and determines whether the time measured by the timer reaches a predetermined time (e.g., a few seconds), i.e., determines whether the timer expires (step S25). When the time measured by the timer reaches the predetermined time (“YES” at step S26), the controller 407 outputs the second drive command signal to the rear wiper 406 to drive the rear wiper 406, thereby performing the washing operation of the rear wiper 406 to wash the window surface 13a (step S26). In this case, the controller 407 can continue the washing operation of the rear wiper 406 only for a predetermined period of time (for example, a few seconds) or can repeat the washing operation of the rear wiper 406 only a predetermined number of times (for example, a few times). In the washing operation of the rear wiper 406, the rear wiper 406 slides over the window surface 13a so that the washing fluid flowing to the window surface 13a can spread over the window surface 13a. Thus, the washing operation of the rear wiper 406 can remove the foreign matters sticking to the window surface 13a along with the washing fluid over a wide area of the window surface 13a.

When the controller 407 receives the operation detection signal outputted from the heater switch 409 and determines that the heater switch 409 is operated (“YES” at step S22), the controller 407 outputs the third drive commend signal to the heater 404 to drive the heater 404, thereby performing the heating operation of the heater 404 (step S27) to heat the lens surface 5a and the washer nozzle 9. Further, the controller 407 outputs the fourth drive commend signal to the heater 404 to drive the heater 404, thereby performing the heating operation of the defogger wire 405 (step S28) to heat the window surface 13a. That is, the heat generated by the heater 404 is transmitted to the entire side periphery of the lens 5 of the camera 3 and also transmitted to the tip end 9b side of the washer nozzle 9, and the heat generated by the defogger wire 405 is transmitted to the rear window 13. In this case, the controller 407 can continue the heating operation of the heater 404 and the heating operation of the defogger wire 405 only for a predetermined period of time. Alternatively, the controller 407 can continue the heating operation of the heater 404 and the heating operation of the defogger wire 405 only while a user is operating (for example, pressing) the heater switch 409.

As described above, the washing operation of the rear wiper 406 to wash the window surface 13a is performed after the washing operation of the washer nozzle 9 to wash the lens surface 5a is performed. In such an approach, even when the washer fluid used to wash the lens surface 5a is left on the window surface 13a, the washer fluid left on the window surface 13a is suitably removed by the washing operation of the rear wiper 406 so that a user's view can be suitably ensured. Further, since the washer fluid left on the window surface 13a is spread widely over the window surface 13a by the washing operation of the rear wiper 406, relatively lightweight foreign matters, such as clouds of dust, sticking to the window surface 13a can be removed together with the washer fluid left on the window surface 13a.

That is, the fact that the washer fluid used to wash the lens surface 5a is left on the window surface 13a without slipping off the window surface 13a means that there is a possibility that foreign matters interrupting the flow of the washer fluid can stick to the window surface 13a. Since the washing operation of the rear wiper 406 removes not only the foreign matters sticking to the window surface 13a but also the washer fluid left on the window surface 13a, a user's view can be suitably ensured.

Further, the washing operation of the rear wiper 406 to wash the window surface 13a starts after the predetermined time has elapsed from when the washing operation of the washing nozzle 9 to wash the lens surface 5a starts. In such an approach, the washer fluid on the window surface 13a is removed at an appropriate timing that is determined by taking into consideration a delay from when the washer fluid is spayed from the washer nozzle 9 to when the washer fluid falls on the window surface 13a. Further, since the washing operation of the rear wiper 406 to wash the window surface 13a can start after the washer fluid sprayed from the washer nozzle 9 falls on the window surface 13a, the rear wiper 406 and the window surface 13a can be prevented from damage due to friction between the rear wiper 406 and the window surface 13a, and production of annoying noise due to the friction can be prevented.

Further, since the lens surface 5a can be heated by the heating operation of the heater 404, it is less likely that snow and ice accumulate on the lens surface 5a and that the lens surface 5a fogs up. Even when snow and ice accumulate on the lens surface 5a, the accumulating snow and ice can be melted and removed by the heating operation of the heater 404 to prevent the snow and ice from blocking the view of the camera 3. Further, since the washer nozzle 9 can be heated by the heating operation of the heater 404, the washer fluid in the washer nozzle 9 can be prevented from freezing. Further, since the window surface 13a can be heated by the heating operation of the defogger wire 405, it is less likely that snow and ice accumulate on the window surface 13a and that the window surface 13a fogs up. Even when snow and ice accumulate on the window surface 13a, the accumulating snow and ice can be melted and removed by the heating operation of the defogger wire 405 to prevent the snow and ice from blocking the view of the user.

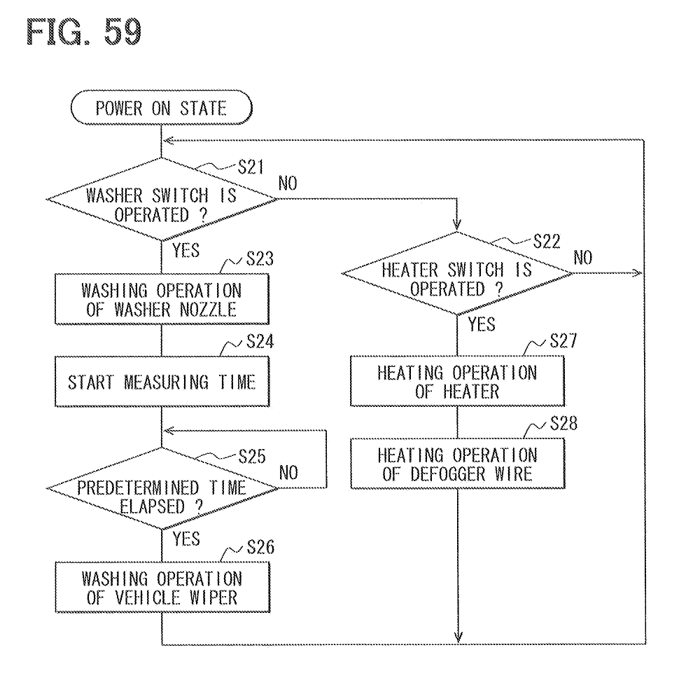

As shown in FIG. 59, when the washer switch 408 is operated (“YES” at step S21), both the washing operation of the washer nozzle 9 to wash the lens surface 5a (step S23) and the washing operation of the rear wiper 406 to wash the window surface 13a (step S26) are performed. However, for example, when the window surface 13a is coated with a water repellent film, it is less likely that the washer fluid used to wash the lens surface 5a is left on the window surface 13a. In such a case, the user may feel that there is no need to perform the washing operation of the rear wiper 406. To satisfy the user's demand, it can be determined, based on a time period during which the washer switch 408 is operated, whether both the washing operation of the washer nozzle 9 and the washing operation of the rear wiper 406 are performed or only the washing operation of the washer nozzle 9 is performed. For example, in a case where the washer switch 408 is a push switch (e.g., a non-latching switch), only the washing operation of the washer nozzle 9 can be performed, when the washer switch 408 remains pushed for a first time period less than a predetermined time period. In contrast, both the washing operation of the washer nozzle 9 and the washing operation of the rear wiper 406 can be performed, when the washer switch 408 remains pushed for a second time period equal to or greater than the predetermined time period.

When the washer switch 408 is operated, the washing operation of the rear wiper 406 is performed in conduction with the washing operation of the washer nozzle 9. That is, the washer switch 408 can trigger not only the washing operation of the washer nozzle 9 but also the washing operation of the rear wiper 406. In such an approach, the user can cause both the washing operation of the washer nozzle 9 and the washing operation of the rear wiper 406 to be performed by merely operating a single washer switch 408. Further, since there is no need to add separate washer switches for the washing operation of the washer nozzle 9 and the washing operation of the window surface 10a to the optical sensor unit 401, the cost and size of the optical sensor unit 401 can be reduced.

Alternatively, the washing operation of the washer nozzle 9 and the washing operation of the rear wiper 406 can be triggered by separate switches. Alternatively, the washing operation of the washer nozzle 9 and the washing operation of the rear wiper 406 can be triggered, for example, upon detection of the fact that the gear is shifted into a reverse position, upon detection of the fact that the IG switch is switched from an OFF state to an ON state, upon detection of the fact that the IG switch is switched from the ON state to the OFF state, and upon detection of the fact that the image contains dirt.

Further, when the heater switch 409 is operated, the heating operation of the heater 404 to heat the lens surface 5a and the washer nozzle 9 is performed in conduction with the heating operation of the defogger wire 405 to heat the window surface 13a. That is, the heater switch 409 can trigger not only the heating operation of the heater 404 but also the heating operation of the defogger wire 405. In such an approach, the user can cause both the heating operation of the heater 404 and the heating operation of the defogger wire 405 to be performed by merely operating a single heater switch 409. Further, since there is no need to add separate heater switches for the heating operation of the heater 404 and the heating operation of the defogger wire 405 to the optical sensor unit 401, the cost and size of the optical sensor unit 401 can be reduced.

Alternatively, the heating operation of the heater 404 and the heating operation of the defogger wire 405 can be triggered by separate switches. Alternatively, the heating operation of the heater 404 and the heating operation of the defogger wire 405 can be triggered, for example, upon detection of the fact that an ambient temperature measured by a temperature sensor is less than a predetermined temperature and upon detection of the fact that a snow sensor detects snow.

The lens 5 and the washer nozzle 9 are heated by a common heather 404. Alternatively, the lens 5 and the washer nozzle 9 can be heated by separate heaters. Alternatively, the heather 404 can heat only one of the lens 5 and the washer nozzle 9. Alternatively, the heather 404 can heat the entire washer nozzle 9.

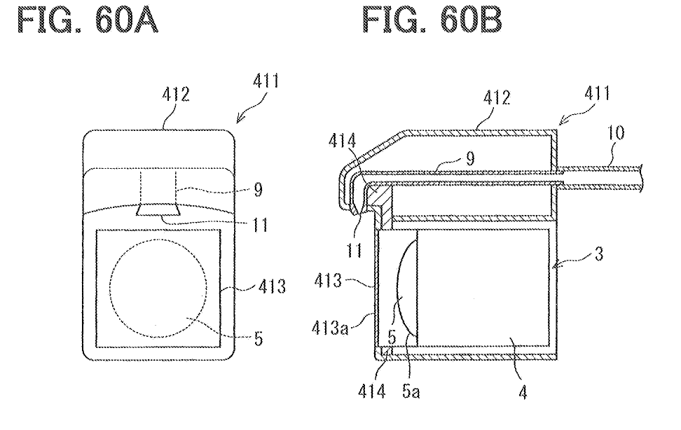

For example, the above modification can be further modified as shown in FIGS. 60A and 60B. In FIGS. 60A and 60B, a casing 412 of a camera cover 411 is provided with a transparent cover glass 413, and the cover glass 413 is located on the front side of the casing 412 so as to face the lens 5 of the camera 3. The washer fluid is splayed from the spray opening 11 onto a glass surface 413a of the cover glass 413. A heater 414 and a wire (not shown) for supplying an electric current to the heater 414 are located in the casing 412. The heater 414 covers the entire side periphery of the cover glass 413 and is in contact with a portion of the washer nozzle 9 on the tip end 9b side. When the controller 407 determines that the heater switch 409 is operated, the controller 407 performs a heating operation of the heater 414 to heat the glass surface 413a and the washer nozzle 9 and performs the heating operation of the defogger wire 405 to heat the window surface 13a.

The optical sensor unit 401 can be located above a window other than the rear window 13 of the vehicle body 12. For example, the optical sensor unit 401 can be located above a side window of the vehicle body 12.

Such changes and modifications are to be understood as being within the scope of the present invention as defined by the appended claims.

What is claimed is:

1. An on-board optical sensor cover comprising:
a holder for holding an optical sensor, the optical sensor having a lens and mounted above a window of a vehicle outside the vehicle; and
a washer nozzle for performing a washing operation to wash a lens surface of the lens of the optical sensor held in the holder or a glass surface of a cover glass located facing the lens by spraying a washer fluid, supplied from a washer fluid tank, onto the lens surface or the glass surface, wherein
the optical sensor cover is located above the window outside the vehicle so that the washer fluid spayed from the washer nozzle flows to a window surface of the window after washing the lens surface or the glass surface.

2. An on-board optical sensor apparatus comprising:
the on-board optical sensor cover defined in claim 1; and
a control device for causing the washer nozzle to perform the washing operation and for causing a wiper of the vehicle to perform a wiping operation to wash a window surface of the window by wiping the window surface, wherein
the control device interlocks the washing operation of the washer nozzle and the wiping operation of the wiper.

3. The on-board optical sensor apparatus according to claim 2, further comprising:
an operation member operable by a user, wherein
when the operation member is operated, the control device causes the washer nozzle to perform the washing operation and causes the wiper to perform the washing operation.

4. The on-board optical sensor apparatus according to claim 3, wherein
when the operation member is operated for a first time period less than a predetermined time period, the control device causes the washer nozzle to perform the washing operation and prevents the wiper from performing the wiping operation, and
when the operation member is operated for a second time period equal to or greater than the predetermined time period, the control device causes the washer nozzle to perform the washing operation and causes the wiper to perform the wiping operation.

5. The on-board optical sensor apparatus according to claim 2, wherein
the control device causes the wiper to start the wiping operation after a predetermined time period elapses from when the control device causes the washer nozzle to start the washing operation.

6. The on-board optical sensor apparatus according to claim 2, further comprising:
a first heater for performing a first heating operation to heat at least one of the lens surface, the glass surface, and the washer nozzle; and
a second heater for performing a second heating operation to heat the window surface, wherein
the control device causes the first heater to perform the first heating operation and causes the second heater to perform the second heating operation in such a manner that the first heating operation and the second heating operation are interlocked with each other.

7. An on-board optical sensor apparatus comprising:
the on-board optical sensor cover defined in claim 1;
a first heater for performing a first heating operation to heat at least one of the lens surface, the glass surface, and the washer nozzle;
a second heater for performing a second heating operation to heat the window surface; and
a control device for causing the first heater to perform the first heating operation and for causing the second heater to perform the second heating operation, wherein
the control device interlocks the first heating operation of the first heater and the second heating operation of the second heater.

8. The on-board optical sensor apparatus according to claim 6, further comprising:
an operation member operable by a user, wherein
when the operation member is operated, the control device causes the first heater to perform the first heating operation and causes the second heater to perform the second heating operation.

9. The on-board optical sensor apparatus according to claim 7, further comprising:
an operation member operable by a user, wherein
when the operation member is operated, the control device causes the first heater to perform the first heating operation and causes the second heater to perform the second heating operation.
